(19) United States
(12) Patent Application Publication
(10) Pub. No.: US 2026/0290349 A1
(43) Pub. Date: Sep. 24, 2026

(54) SYSTEM

(71) Applicant: SoftBank Group Corp., Tokyo (JP)

(72) Inventor: Ryo TAKETOMI, Tokyo (JP)

(73) Assignee: SoftBank Group Corp., Tokyo (JP)

(21) Appl. No.: 19/566,236

(22) Filed: Mar. 13, 2026

(30) Foreign Application Priority Data
Mar. 19, 2025 (JP) 2025-045099

(51) Int. Cl. G10L 17/06; G06N 3/0475; G06N 3/091; G10L 13/08; G10L 15/26; H04L 51/02

(52) U.S. Cl. CPC G10L 17/06; G06N 3/0475; G06N 3/091; G10L 13/08; G10L 15/26; H04L 51/02

(57) ABSTRACT

A system includes a processor that is configured to acquire voice data and convert the voice data into text data, analyze the text data to determine a possibility of fraud, and generate a prompt for instructing a generative artificial intelligence model to generate a response.

### CROSS-REFERENCE TO RELATED APPLICATION

This application is based on and claims priority under 35 USC 119 from Japanese Patent Application No. 2025-045099 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for preventing fraud in voice communications, such as telephone calls or voice over IP sessions, generally rely on human judgment and simple rule-based screening, and therefore often fail to detect sophisticated or newly emerging fraud schemes. Elderly users and other vulnerable users, in particular, may have difficulty in recognizing fraudulent behaviors during real-time conversations and in responding appropriately. Moreover, known systems that merely record calls or perform keyword spotting do not provide dynamic, context-aware interaction with a caller, and do not make effective use of recent advances in generative artificial intelligence models. As a result, there is a need for a system that can automatically convert voice data into text data, analyze the text data to determine a possibility of fraud with improved accuracy, and generate appropriate responses using a generative artificial intelligence model. There is also a need for the system to learn typical fraud patterns using machine learning algorithms and to notify a user in real time when a fraud attempt is detected, thereby reducing the burden on the user and improving protection against fraud.

### SUMMARY

In order to solve the above-described problems, a system according to one embodiment of the present invention comprises a processor, wherein the processor is configured to acquire voice data and convert the voice data into text data, analyze the text data to determine a possibility of fraud, and generate a prompt for instructing a generative artificial intelligence model to generate a response. The processor may be further configured to learn typical fraud patterns using a machine learning algorithm and to respond based on a result of the learning, thereby improving the accuracy and adaptability of fraud detection and response over time. Furthermore, the processor may be configured to generate a notification message for notifying a user when a fraud attempt is detected, and to transmit the notification message to a terminal of the user, so that the user can be promptly alerted to the potential fraud and can take appropriate action.

The term “system” refers to an arrangement of hardware, software, or a combination thereof, including at least one processor and associated memory and interfaces, configured to perform the processing operations described in the claims.

The term “processor” refers to any processing circuitry, including but not limited to a central processing unit (CPU), microprocessor, digital signal processor (DSP), microcontroller, application specific integrated circuit (ASIC), field programmable gate array (FPGA), or a combination of two or more of these, capable of executing instructions to perform the claimed functions.

The term “voice data” refers to data representing spoken audio, including analog or digital audio signals, or encoded or compressed representations of such signals, obtained for example from a microphone or a communication network.

The term “text data” refers to character data or symbolic data that represent words, phrases, or sentences corresponding to spoken content in the voice data, for example as output by a speech recognition process.

The term “analyze the text data” refers to performing at least one of parsing, pattern matching, statistical evaluation, semantic analysis, or machine learning based inference on the text data in order to extract features, identify patterns, or derive conclusions relevant to fraud detection.

The term “possibility of fraud” refers to a likelihood, probability, risk level, or determination that the content of a communication corresponds to or suggests fraudulent behavior, a fraud attempt, or a suspicious pattern associated with fraud.

The term “fraud” refers to deceptive or dishonest conduct, including but not limited to special fraud schemes, financial scams, impersonation schemes, and other malicious attempts to obtain money, personal information, or other benefits from a user through misleading voice communications.

The term “prompt” refers to a data structure, instruction set, or input sequence, including natural language text or formatted control tokens, that is provided to a generative artificial intelligence model to specify constraints, context, or instructions for generating an output response.

The term “generative artificial intelligence model” refers to a machine learning model, such as a neural network based language model or multimodal model, configured to generate new content, including text, audio, or other media, in response to an input prompt.

The term “response” refers to output data generated by the generative artificial intelligence model based on the prompt, including but not limited to text responses, suggested utterances, or content to be converted into speech for presentation to a caller or a user.

The term “machine learning algorithm” refers to an algorithm or model that automatically adjusts its internal parameters based on training data, including but not limited to supervised learning, unsupervised learning, or reinforcement learning techniques, in order to improve its ability to recognize fraud patterns.

The term “typical fraud patterns” refers to characteristic combinations of words, phrases, structures, or contextual indicators that are commonly observed in known fraud schemes, such as grandchild scams, refund scams, or similar deceptive communications.

The term “learn” refers to the process of training or updating the machine learning algorithm or model using example data, labels, or feedback, in order to improve its performance in detecting or classifying fraud-related content.

The term “fraud attempt” refers to an instance in which the system determines, based on analysis of the text data and the learned patterns, that the communication likely represents or includes fraudulent behavior or a scam in progress.

The term “notification message” refers to information generated by the processor for the purpose of informing a user about a detected fraud attempt or a possibility of fraud, the information being suitable for presentation as text, audio, visual indicators, or other alert forms.

The term “user” refers to a person who owns, operates, or is protected by the system, and who receives notifications or assistance from the system in relation to fraud detection.

The term “terminal” refers to an end-user device associated with the user, such as a smartphone, feature phone, fixed-line telephone device, computer, tablet, or other communication apparatus, capable of receiving data from the system and presenting notifications or responses to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

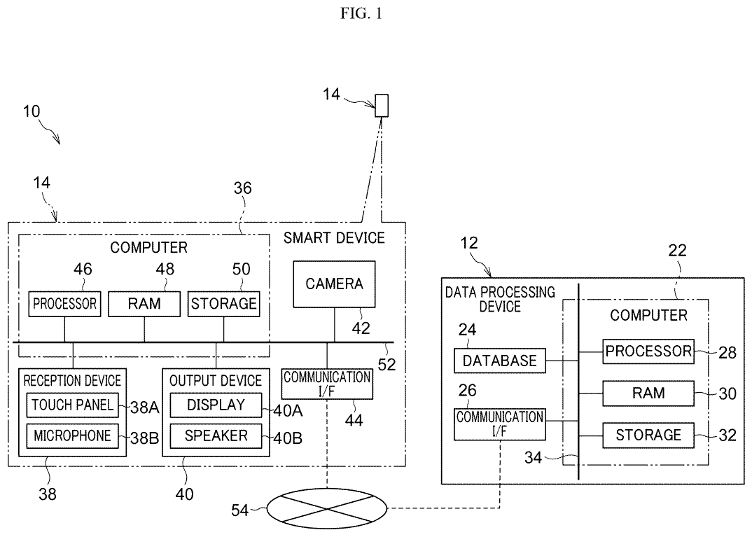

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

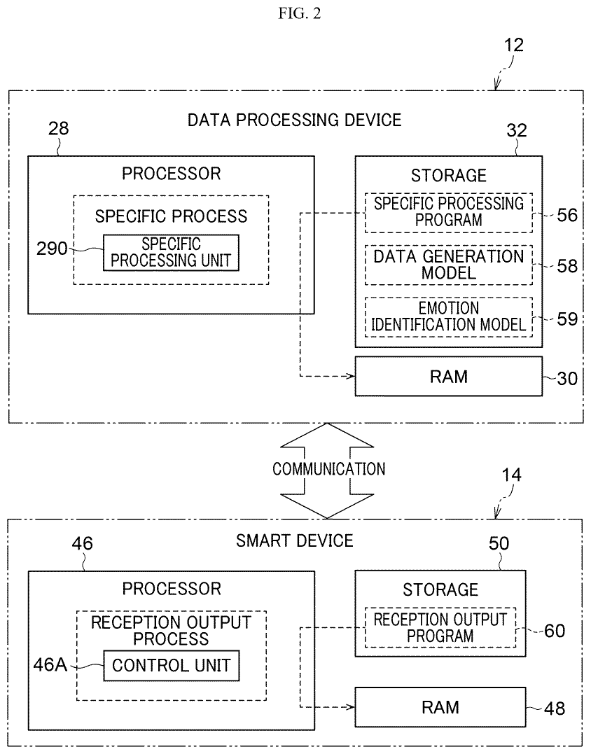

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional telephone fraud protection techniques rely heavily on static rule sets, simple keyword spotting, or manual operator intervention. From a computer-technology perspective, such techniques suffer from several technical limitations in how communication data is processed and how intelligent assistance is integrated into real-time communication.

First, existing systems typically perform fraud detection as an offline analysis or as a background check, separate from the actual communication path. Audio streams of calls are not processed in an end-to-end pipeline that consistently converts voice to text, applies a learned fraud risk model, and feeds a generative model in a closed loop. As a result, conventional architectures cannot reliably provide timely and context-aware responses during an ongoing call, leading to latency, dropped interactions, or failure to intervene before sensitive information is disclosed.

Second, many systems treat speech recognition, fraud detection, and response generation as isolated modules without a unified control of prompt generation for a generative AI model. This fragmented design prevents the system from dynamically adjusting the behavior of the generative AI model according to a calculated fraud risk level. In particular, the prompt sentence sent to the generative AI model is often static or generic, failing to exploit the full context of the transcribed text and risk analysis. This limits the technical capability of the computing system to produce appropriate, efficient, and safe automated responses.

Third, typical fraud alert mechanisms only generate simple notifications to a user device, such as a pop-up warning or a generic message. They do not integrate the recognized text, the risk evaluation, and the automatically generated response content into a coherent notification optimized for user understanding and further action. Consequently, the human-computer interaction remains suboptimal, and the user interface does not fully leverage the internal analysis performed by the computing components.

Fourth, in many telephony environments, the switching between a user-handled call and an AI-handled call requires multiple operations, complex menu navigation, or external devices. This leads to increased user burden and delays the activation of protective AI functions, especially for users with limited technical literacy. From a system design standpoint, such interaction patterns fail to make effective use of the underlying communication and audio pipelines and reduce the overall reliability of the protection system in real-time scenarios. Accordingly, there is a need for a computer-implemented technique that improves the way a processor handles real-time audio data, transforms it into text, assesses fraud risk using a learned model, dynamically constructs a prompt sentence tailored to that risk, invokes a generative AI model to generate an appropriate response, and converts the response back to voice for immediate output during the call. There is also a need to improve the technical manner in which notification information is generated and delivered to the user terminal by combining risk metrics, transcribed content, and AI-generated responses. By addressing these issues, the invention aims to provide a technically improved communication processing system that enhances the efficiency, accuracy, and responsiveness of fraud protection in voice communications.

The specific processing by the specific processing unit 290 of the data processing device 12 in Example 1 is realized by the following means.

The present invention provides a server comprising a processor configured to acquire voice data from a communication path, convert the voice data into text data, analyze the text data to determine a possibility of fraud, generate a prompt sentence including conditions for response generation to a fraud scene based on an analysis result and the text data, input the prompt sentence to a generative AI model to cause the generative AI model to generate a response as text, convert the generated text into voice data, transmit the voice data to a counterpart terminal so that the voice data is output as an automatic response during a call, in response to a single operation instruction from a user terminal switch a call response mode from a user response to the automatic response, apply to the text data a determination model learned by a machine learning scheme using typical expression patterns of fraud and fraud risk indices, calculate presence or absence of the possibility of fraud and a fraud risk level based on an output of the determination model, dynamically change a response policy and a response style included in the prompt sentence according to the fraud risk level, and when the possibility of fraud is determined to exceed a predetermined criterion, generate notification information including at least the fraud risk level, a part of the text data, and a summary of response content generated by the generative AI model, transmit the notification information to the user terminal, and cause the user terminal to display the notification information. This enables an integrated, processor-implemented pipeline that improves computer functionality by performing real-time transformation of call audio into analyzed text, adaptive prompt construction for a generative AI model based on learned fraud risk evaluation, immediate synthesis and transmission of an automatic voice response during the call in response to a single user operation, and generation of enriched notification information that efficiently exposes internal analysis and AI output to the user, thereby enhancing the technical performance, responsiveness, and reliability of fraud protection in voice communication systems.

The term “voice data” refers to data representing acoustic signals captured during a communication, including analog or digital representations of spoken utterances transmitted over a communication path.

The term “text data” refers to character-based data obtained by converting voice data into a sequence of textual symbols using a speech recognition process.

The term “analyze the text data” refers to performing computational processing on the text data, including but not limited to tokenization, pattern matching, classification, and inference, in order to derive semantic or contextual information.

The term “possibility of fraud” refers to a likelihood, probability, or risk level that a given communication is associated with fraudulent activity, as evaluated by a computational model or rule set.

The term “prompt sentence” refers to a text input provided to a generative AI model, the text input including instructions, conditions, and contextual information that guide the generation of a response.

The term “conditions for response generation” refers to parameters, constraints, or guidelines included in a prompt sentence that specify how a response should be generated, such as tone, length, language, and safety constraints.

The term “fraud scene” refers to a communication context in which at least part of the content is indicative of a potential fraudulent attempt, such as a request for confidential information or an urgent transfer of value.

The term “generative AI model” refers to a computational model that generates text or other content in response to a given input, the computational model being based on machine learning techniques such as neural networks or transformer architectures.

The term “automatic response” refers to a response generated and output by the system without requiring the user to manually compose or speak the content of the response.

The term “communication path” refers to a medium or channel through which voice data or other signals are transmitted between a user terminal and a counterpart terminal, including wired and wireless networks.

The term “counterpart terminal” refers to a communication device at a remote side of a call that receives voice data output as an automatic response.

The term “user terminal” refers to a communication device operated by a user, capable of receiving calls, sending and receiving data to and from the server, and presenting information to the user.

The term “single operation instruction” refers to an instruction generated by one user interaction, such as pressing a button or performing a single touch or gesture, that is detected as a single operation event.

The term “call response mode” refers to an operational state of a communication system specifying whether a call is handled by a human user, by an automatic response function, or by a combination thereof.

The term “determination model” refers to a computational model configured to evaluate text data and output a determination related to fraud, the computational model being trained using a machine learning scheme.

The term “machine learning scheme” refers to a method or process in which a computational model is trained using example data so that the model learns to perform tasks such as classification, prediction, or pattern recognition.

The term “typical expression patterns of fraud” refers to textual or linguistic patterns that frequently appear in fraudulent communications, such as characteristic phrases, wording, or sentence structures.

The term “fraud risk indices” refers to numerical or categorical indicators that represent the degree or category of fraud risk associated with a communication.

The term “fraud risk level” refers to a quantitative or qualitative value derived from fraud risk indices or model outputs, indicating the severity or probability of fraud.

The term “response policy” refers to a set of rules or guidelines that define what kind of response should be generated in a given situation, including whether to refuse information, request verification, or terminate the conversation.

The term “response style” refers to characteristics of how a response is expressed, including tone, politeness level, formality, and degree of detail.

The term “predetermined criterion” refers to a threshold or condition defined in advance and used by the system to decide whether the possibility of fraud is sufficiently high to trigger specific processing.

The term “notification information” refers to data generated by the system for presentation to the user, the data including at least a fraud risk level, a part of the text data, and a summary of response content.

The term “summary of response content” refers to a condensed representation of a response generated by the generative AI model, highlighting essential points without including all details of the full response.

In embodiments of the present invention, a server, a terminal, and a user cooperate to implement a real-time fraud protection system for voice communications. The system executes concrete data processing on specific hardware and software components so that the server performs integrated audio acquisition, transformation, analysis, prompt construction, generative AI inference, and response synthesis. The system thus improves computer functionality in communication processing, beyond mere automation of human judgment.

### A. Overall Configuration

A server includes at least one processor, a main memory, a non-volatile storage device, and a network interface. The server operates under a server operating system such as a generic server operating system, and executes application software implemented for example in a high-level programming language. The server may be implemented on a general-purpose computer platform, on dedicated server hardware, or on a virtual machine instance in a cloud computing environment. The server may also include one or more hardware accelerators such as graphics processing units, tensor processing units, or other specialized accelerators for neural network computation.

A terminal includes a processor, a memory, a wireless communication interface, an audio input device, an audio output device, and a user interface display. The terminal operates under a mobile operating system such as a generic mobile operating system, and runs an application program that implements interaction with the server. The terminal may be a smartphone, a tablet, a wearable device, or any other communication terminal capable of making voice calls and executing an application.

A user operates the terminal through a user interface. The user initiates and receives calls, and issues a single operation instruction, for example by pressing a dedicated button or activating a specific touch area, to switch the call response mode from user response to automatic response.

### B. Functional Modules on the Terminal

The terminal executes an application that includes at least a call control module, an audio capture module, a network communication module, a text-to-speech module, and a user interface module.

The terminal uses the audio capture module to obtain call audio through an audio input path exposed by the mobile operating system. The terminal uses a codec hardware and an audio framework such as a generic audio framework to sample the analog voice signal and convert it into digital pulse code modulation data. The terminal arranges the digital data into a specific data structure, for example a ring buffer or a fixed-size frame array, where each frame is annotated with metadata including a timestamp, a sampling rate, a channel count, and a session identifier.

The terminal uses the network communication module to open a secure channel such as a secure transport channel to the server. The terminal serializes each frame with its metadata into a packet, for example using a binary framing format or a structured text format, and transmits the packet to the server. The terminal implements retransmission control, buffering, and backpressure handling so that the audio stream remains continuous even under varying network conditions. This concrete packetization and transmission design reduces latency and packet loss compared to generic bulk transfer, thereby improving responsiveness in real-time fraud defense.

The terminal uses the user interface module to detect the single operation instruction. When the user presses the button, the terminal sets an internal state variable for example to represent an automatic response mode. The terminal thereby controls the program flow to route call audio to the server without requiring multi-step operations. This reduces user interaction overhead and shortens the time to activation of the protection pipeline, which is critical for early interception of fraudulent requests.

The terminal uses the text-to-speech module to synthesize an automatic response sent from the server. The terminal supplies a response text string to a synthesis engine provided by the operating system or by a cloud service. The terminal configures synthesis parameters, including language identifier, speaking rate, and prosody, and stores synthesized audio samples in a playback buffer. The terminal then routes the buffer to an audio output device via the audio framework so that the remote counterpart terminal hears the automatic response. This concrete synthesis and routing mechanism allows the server-generated response to be integrated into the ongoing call without re-encoding the entire call stream, which reduces computation load and avoids additional transcoding errors.

### C. Functional Modules on the Server

The server executes an application that includes at least a session management module, an audio pre-processing module, a speech recognition module, a text analysis module, a fraud determination module, a prompt generation module, a generative AI module, a response post-processing module, and a notification generation module.

The server uses the session management module to maintain a mapping between terminal sessions and internal structures. The server allocates, for each active call, a session record stored in memory or a fast-access data store. The session record holds fields such as a session identifier, the current fraud risk level, a transcript buffer, and configuration flags. By maintaining explicit per-session structures, the server can parallelize processing across cores and accelerators and can avoid repeated setup costs, which improves throughput and scalability.

The server uses the audio pre-processing module to reassemble audio frames received from the terminal. The server performs operations such as decoding codec formats into linear pulse code modulation, normalizing amplitude, and segmenting the stream into analysis windows of a specified duration. The server stores each window in a buffer associated with the session. This segmentation uses sliding-window indexing so that overlapping windows can be formed without copying the entire buffer, thereby reducing memory overhead and improving computational efficiency.

The server uses the speech recognition module to convert voice data into text data. The server may employ a neural network-based acoustic and language model, such as an encoder-decoder architecture with attention or a transformer-based model. The server feeds each window of audio samples into the recognizer, which outputs a sequence of tokens representing text. The server concatenates sequences from successive windows and applies a text alignment procedure to remove duplication or overlap at window boundaries. This design provides a continuous transcript with low latency and reduced error accumulation relative to processing entire calls as a single batch.

### D. Fraud Determination and Prompt Sentence Generation

The server uses the text analysis module and the fraud determination module to evaluate a possibility of fraud from the text data. The server tokenizes the transcript into sentences and words, normalizes number expressions, and extracts candidate features such as n-gram counts, part-of-speech tags, dependency relations, and entities representing monetary values, account identifiers, and institutional names. The server maps these features into a numerical feature vector using a predetermined vocabulary and embedding functions. For example, the server may employ word embeddings or contextual embeddings produced by a transformer encoder.

The server applies a determination model that has been trained via a machine learning scheme. In one embodiment, the determination model is a neural network classifier with multiple layers. The model includes an input layer receiving the feature vector, one or more hidden layers composed of fully connected units or transformer blocks, and an output layer that produces a probability distribution over categories such as “fraud suspected” and “fraud not suspected.” The server has trained this model in advance on labeled training data containing examples of fraudulent and non-fraudulent transcripts. The server uses a loss function such as cross-entropy and an optimization algorithm such as stochastic gradient descent or its variants to adjust model weights. The server may apply regularization techniques such as dropout, batch normalization, and data augmentation in the text domain to improve generalization and robustness.

The server computes, from the output of the determination model, a fraud risk level, for example a value between zero and one. The server may further classify the type of fraud, such as impersonation of financial institutions or impersonation of family members. The server stores the fraud risk level and the category in the session record. Compared to simple keyword matching, this trained determination model can capture non-obvious patterns and contextual cues, thereby increasing detection accuracy and reducing both false positives and false negatives.

The server uses the prompt generation module to construct a prompt sentence for a generative AI model. The server selects recent utterances from the transcript, for example the last several sentences spoken by the counterpart. The server also retrieves the current fraud risk level and category from the session record. The server constructs a prompt sentence that includes: an instruction segment defining the role of the generative AI model, a context segment including the extracted utterances, and a control segment specifying a response policy and response style determined from the fraud risk level.

For example, when the fraud risk level is high and the transcript includes a request for a personal identification number, the server may construct the following prompt sentence: “You are a voice AI assistant protecting an elderly user from phone fraud.

The caller just said: ‘We are calling from your bank. Please tell us your cash card PIN so we can secure your account.’

Generate a concise, polite, and firm response in Japanese that refuses to give any PIN or personal information and advises the caller that such requests are not accepted over the phone.”

In another example, when a caller impersonates a family member and requests urgent funds, the server may construct the following prompt sentence: “You are a generative AI model acting as a protective voice assistant for an elderly user.

The caller said (in Japanese): ‘Grandma, I made a mistake and I need 500,000 yen urgently. Please transfer it today. I will send the account number now.’

Generate a polite but firm response in Japanese that:
1) refuses to immediately transfer any money,
2) suggests confirming the situation directly with the real family member through a known phone number, and
3) avoids giving any bank or personal information.”

The server thereby dynamically adapts the content and style of the prompt sentence based on quantitative risk evaluation and feature extraction. This is not simply automating a human script, but rather defining a closed feedback loop between the fraud determination module and the generative AI model. This feedback loop enables the computer system to change its own generative behavior in a technically meaningful way, improving robustness and appropriateness of responses.

### E. Generative AI Model Structure and Response Synthesis

The server uses the generative AI module to generate a response text based on the prompt sentence. In one embodiment, the generative AI model is a transformer-based language model composed of multiple encoder-decoder or decoder-only layers. Each layer includes multi-head self-attention mechanisms, feed-forward networks, and normalization components. The server stores the model parameters in memory and loads them into an accelerator for inference. The server splits the prompt sentence into tokens by a tokenizer that maps text units to integer indices. The server feeds the sequence of indices to the generative AI model, which iteratively computes attention weights and hidden representations for each token according to the learned weight matrices.

The server controls generation parameters such as maximum output length, sampling temperature, and top-k or top-p sampling thresholds. By tuning these parameters programmatically, the server can enforce deterministic or conservative behavior when the fraud risk level is high, and can allow slightly more variation when the risk is low. This algorithmic control of generation behavior based on internal risk metrics constitutes a specific technical improvement in how a generative model is used, as it reduces the likelihood of unsafe or misleading outputs that could occur under uncontrolled free-form generation.

The server uses the response post-processing module to analyze and sanitize the generated text. The server checks whether the response text includes any instruction to provide sensitive data or any content that might inadvertently encourage the user to comply with fraudulent requests. The server may apply rule-based filters or a secondary classifier to the generated text to ensure compliance with safety constraints. If the generated text fails a safety check, the server regenerates a response with stricter parameters or a modified prompt sentence. This multi-stage generation and filtering pipeline improves safety and reliability beyond a naive application of generative models.

The server then transmits the final response text to the terminal. The terminal converts the response text into synthesized speech and injects the audio into the call. The system thus implements a complete technical chain from raw audio to automatic spoken response, with internal adaptive decision-making based on machine learning outputs.

### F. Notification Generation and User Feedback

The server uses the notification generation module to produce notification information for the user terminal when the possibility of fraud exceeds a predetermined criterion. The server composes a notification record that includes the fraud risk level, selected parts of the transcript such as key phrases indicating fraud, and a summary of the response content generated by the generative AI model. The server may generate the summary by applying a summarization algorithm, such as extracting top-scoring sentences based on attention weights or using a secondary summarization model.

The server sends the notification record to the terminal via the network interface. The terminal displays the notification information on the user interface, for example as a dialog box showing risk level indicators and central phrases from the call. This design allows the user to understand, in a compact form, why the server has classified the call as risky and how the system responded. This transparency assists the user in making informed decisions and differentiates the system from simple black-box alert mechanisms.

### G. Technical Effects and Improvement of Computer Technology

The described embodiments provide several specific technical effects in the sense of improving the operation of computer systems.

The server reduces end-to-end latency by structuring the audio stream into overlapping analysis windows and by performing streaming speech recognition, rather than batch processing of entire calls. This allows the system to generate responses within short time intervals, which is critical in real-time protection scenarios.

The server improves fraud detection accuracy by using a trained determination model that exploits contextual and structural features of the transcript. This goes beyond simple keyword matching and results in lower error rates. The link between the output of this determination model and the prompt generation process further refines response selection, improving the precision of automatic responses.

The server improves resource efficiency by separating the recognition, determination, prompt generation, and generative inference into pipeline stages that can be parallelized and scaled independently. For example, speech recognition may run on one accelerator type, whereas the generative AI model runs on another. This modular design reduces computation waste and allows dynamic allocation of resources based on current call volume and risk level.

The terminal reduces user interaction burden and activation time for protective functions by using a single operation instruction to switch call response modes. This modification of the user interface and control flow results in a measurable improvement in the speed at which the protection pipeline is activated, which in turn reduces the amount of unprotected communication.

The integrated pipeline from audio capture through machine learning-based fraud determination to adaptive prompt generation and real-time speech synthesis is not a generic automation of human processes; instead, it leverages data structures, model architectures, and control algorithms that are not available to human operators. For example, the server uses numerical embeddings, attention matrices, and learned weight updates at inference time to derive nuanced fraud risk levels. These internal computations cannot be replicated by humans in real time and are tightly bound to the architecture of the computing components.

H. Alternative embodiments and variations

The server may employ different types of speech recognition models, such as recurrent neural networks or convolutional architectures, as long as they provide text data from voice data.

The fraud determination model may be replaced with other classifiers, including gradient boosting machines or support vector machines, provided that they operate on structured features derived from the transcript.

The generative AI model may be an encoder-decoder model or a decoder-only model, with different numbers of layers or attention heads. The server may adjust model size according to available hardware, balancing accuracy and latency. The server may also use quantization or pruning techniques to reduce model size while maintaining acceptable performance.

The prompt generation module may include additional control segments, such as legal requirements or institutional policies, and may tailor responses to different user profiles. The notification generation module may provide different visualization levels on the terminal, such as color-coded risk bars or detailed text summaries, depending on user preferences.

In all these variations, the server, the terminal, and the user remain the main actors. The server executes the core processing pipeline, the terminal handles call control, audio interfacing, and user interaction, and the user triggers and monitors the automatic protection. Each component engages in specific, technically defined operations that together provide improved performance, accuracy, and reliability in fraud protection for voice communication systems.

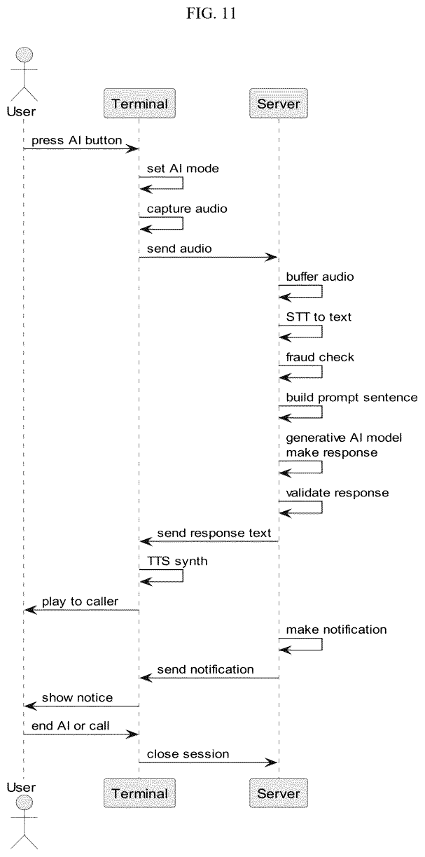

The following describes the processing flow using FIG. 11.

Step 1:

User operates the terminal to activate AI mode.

User presses a designated AI button on the terminal during a call. The input is a physical or touch interaction detected by the terminal's user interface framework. The terminal receives an event object from the operating system, sets an internal state flag such as ‘callMode=AI_MODE’, and updates its call control logic to enable audio capture and server communication for automatic response. The output is an updated internal mode state indicating that subsequent call audio will be processed by the AI pipeline.

Step 2:

Terminal captures call audio and structures it into frames.

Terminal uses an audio framework to read audio samples from the telephony audio path. The input is an analog voice signal from the microphone or telephony stack. The terminal converts the signal into digital PCM samples using an audio codec, groups samples into fixed-size frames (for example, 20 ms per frame), and attaches metadata including a timestamp, sampling rate, and session ID. The terminal stores these frames in a ring buffer or queue. The output is a sequence of audio frame objects ready for network transmission.

Step 3:

Terminal transmits audio frames to the server over a secure channel.

Terminal uses a communication module to open a secure connection to the server. The input is the buffered audio frames and their metadata. The terminal serializes each frame into a packet, applies optional compression, adds headers containing session identifiers and sequence numbers, and sends the packets over a secure transport protocol. The output is a continuous encrypted stream of audio packets delivered to the server.

Step 4:

Server receives and buffers audio stream per session.

Server listens on a network interface for incoming packets from terminals. The input is the encrypted audio packet stream. The server decrypts packets, verifies authentication information and sequence order, and reconstructs audio frames per session ID. The server places frames into a session-specific buffer and organizes them into contiguous windows of audio (for example, 1-3 seconds per window) using index calculations. The output is a set of ordered audio windows stored in memory for each active session.

Step 5:

Server pre-processes audio windows for speech recognition.

Server applies normalization and decoding to each audio window. The input is the raw or compressed audio windows from the buffer. The server decodes any compressed format into linear PCM, normalizes amplitude, resamples if needed to the recognition model's required sample rate, and generates a standardized tensor or array representation suitable for neural network input. The output is a sequence of normalized audio tensors for each window.

Step 6:

Server performs speech recognition to generate text data.

Server uses a speech recognition model to convert audio tensors into text. The input is the normalized audio tensors. The server feeds each tensor into the speech recognition network, which performs matrix multiplications and non-linear activations to compute token probabilities over a vocabulary. The server selects the most probable token sequence via beam search or greedy decoding, concatenates tokens into text strings, and aligns overlapping window outputs to remove duplication at boundaries. The output is a time-ordered transcript segment for each processed window.

Step 7:

Server updates the session transcript with new text segments.

Server maintains a transcript buffer per session. The input is the newly generated transcript segment and its associated timestamps. The server appends the segment to the existing transcript, merges overlapping or repeated text using string comparison or alignment, and stores the updated transcript in the session record in memory or a fast data store. The output is an up-to-date cumulative transcript that represents the content of the call so far.

Step 8:

Server extracts features from recent transcript text.

Server analyzes the latest portion of the transcript to prepare input for fraud determination. The input is a text slice, for example the last several sentences from the transcript. The server tokenizes the slice into words and sentences, identifies parts of speech, detects entities such as monetary amounts and account identifiers, and constructs a feature vector using a vocabulary mapping and embedding functions. The server may also compute n-gram counts and syntactic dependencies. The output is a numerical feature vector representing the recent communication content.

Step 9:

Server applies the fraud determination model and computes fraud risk.

Server feeds the feature vector into a trained determination model. The input is the numerical feature vector from the text analysis. The server performs forward propagation through the model layers, applying learned weight matrices, activations, and possibly attention mechanisms, to compute a probability distribution over fraud-related classes. The server reads the output probabilities, assigns a fraud risk level (for example, a value between 0 and 1), and determines whether the possibility of fraud exceeds a threshold. The output is a fraud classification result and a corresponding fraud risk level stored in the session record.

Step 10:

Server decides whether AI response generation is required.

Server evaluates the fraud risk level and call context. The input is the fraud risk level, the fraud classification label, and session state information. The server performs a conditional check, such as comparing the risk level against a predetermined threshold, and may also consider user or system settings. If the condition is satisfied, the server flags the session as requiring an AI response; otherwise, it continues monitoring without generating a response. The output is a control flag indicating whether to proceed with prompt generation and generative AI processing.

Step 11:

Server constructs a prompt sentence for the generative AI model.

Server builds a structured textual instruction for the generative model. The input is the recent transcript text, the fraud risk level, the fraud category, and predefined templates or policies. The server selects relevant utterances from the transcript, composes an instruction segment that defines the AI's role (for example, protecting the user from fraud), and adds policy constraints (for example, refusing to share personal information). The server concatenates these components into a coherent prompt sentence. The output is a complete prompt sentence that encodes both context and response constraints for the generative AI model.

Step 12:

Server generates response text using the generative AI model.

Server submits the prompt sentence to the generative AI model for inference. The input is the tokenized prompt sentence and generation parameters such as maximum length and temperature. The server feeds the token IDs into the model, which performs multiple layers of self-attention and feed-forward computations to predict the next token distribution iteratively. The server samples or selects tokens according to the configured strategy, assembles them into a response string, and optionally enforces constraints on length or content. The output is a candidate response text tailored to the detected fraud scenario.

Step 13:

Server post-processes and validates the generated response text.

Server checks the generated text against safety and policy rules. The input is the candidate response text from the generative AI model. The server scans the text for forbidden patterns such as requests for passwords or personal identifiers, and may run a secondary classifier or rule engine to validate compliance with safety guidelines. If the response fails validation, the server adjusts the prompt sentence or generation parameters and regenerates a response. The output is a validated response text that satisfies predefined safety and style requirements.

Step 14:

Server sends the validated response text to the terminal.

Server prepares a message containing the response text for transmission. The input is the validated response text and the session identifier. The server wraps the text in a response structure including metadata (for example, time, risk level), serializes the structure, and sends it over the existing secure connection to the terminal. The output is a response message delivered to the terminal, associated with the correct ongoing call session.

Step 15:

Terminal receives and parses the response text message.

Terminal listens on the secure channel for incoming server messages. The input is the serialized response message from the server. The terminal deserializes the message, verifies integrity and session ID, and extracts the response text and relevant metadata. The terminal updates internal state, recording that an automatic response is available for immediate synthesis. The output is a plain text response string stored in terminal memory and ready for text-to-speech processing.

Step 16:

Terminal converts the response text into synthesized speech.

Terminal invokes a text-to-speech engine to generate audio samples. The input is the response text and synthesis settings such as language and speaking rate. The terminal passes the text to the synthesis engine, which performs linguistic analysis, phoneme generation, and waveform synthesis via digital signal processing or a neural vocoder. The terminal receives a buffer of synthesized audio samples and stores them in a playback queue associated with the call. The output is an audio buffer containing the spoken version of the generated response.

Step 17:

Terminal outputs the synthesized speech to the counterpart terminal.

Terminal injects the synthesized audio into the active call audio path. The input is the audio buffer with synthesized speech. The terminal uses the audio framework to route the buffer to the appropriate output stream, mixing or replacing the user's microphone input according to configuration. The terminal sends the audio over the telephony interface so that the counterpart terminal receives and plays the AI-generated response. The output is an audible automatic response heard by the caller on the remote side.

Step 18:

Server generates notification information for the user terminal when fraud is high.

Server prepares a user-facing notification upon high fraud risk. The input is the fraud risk level, parts of the transcript, and the final response text. The server composes a notification object including a textual risk indicator, selected key phrases or sentences from the transcript, and a concise summary of the response content. The server then sends this notification object to the terminal over the secure channel. The output is a structured notification message that allows the terminal to present detailed fraud information to the user.

Step 19:

Terminal displays notification information to the user.

Terminal presents fraud-related information on the user interface. The input is the notification message from the server. The terminal parses the content, maps the risk level to visual indicators (for example, color or icons), formats the transcript excerpts and response summary into readable text, and renders them on the display. The output is a visual notification that informs the user about the detected fraud risk and the automatic response taken by the system.

Step 20:

User optionally terminates AI mode or the call based on notification.

User reviews the notification and listens to the ongoing interaction. The input is the on-screen notification and the audible call context. The user may press a termination or mode switch button on the terminal to stop AI handling or to end the call. The terminal detects this user operation, updates ‘callMode’ back to a normal mode or terminates the telephony session, and notifies the server to close the associated session. The output is a controlled end of the AI-assisted interaction, with the system resources and session state released on both the terminal and the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional fraud-detection systems for voice communications typically rely on static keyword lists, heuristic rules, or offline analysis of recorded calls. Such approaches suffer from several technical limitations when implemented in real-time communication environments. First, static pattern-matching logic running on a processor is unable to robustly cope with variations in natural language expressions, paraphrases, and evolving fraud scenarios, which results in low recall or excessive false positives. Second, many existing systems perform analysis only after the call has ended, which prevents timely intervention during an ongoing communication and fails to support interaction flows that could protect vulnerable users in real time. Third, conventional architectures generally treat speech recognition and fraud detection as loosely connected, sequential components, without a unified control mechanism that manages continuous transcription, dynamic risk scoring, prompt generation for an intelligent model, and user interface feedback as an integrated pipeline. This fragmented processing leads to inefficient use of computational resources, latency accumulation, and poor responsiveness from the perspective of computer system performance.

Furthermore, existing systems do not fully exploit modern generative information processing models in a technically structured manner. In many cases, a generative model is invoked with ad-hoc input text, without systematic construction of prompt sentences that encode context, risk evaluation data, and user interaction policies. This ad-hoc usage makes it difficult for a processor to obtain stable, machine-interpretable outputs that can be transformed into quantitative risk information, resulting in unstable and non-deterministic system behavior. In addition, known systems rarely implement a feedback loop in which the processor continuously updates risk information in a time-series fashion while streaming audio is being converted into text, thereby failing to maintain an accurate, evolving view of the fraud likelihood over the entire duration of the call.

Another technical problem lies in the user interaction layer and control of communication flows at the device and server level. Existing solutions often provide only a generic pop-up warning or passive log entry, without computer-implemented mechanisms that (i) coordinate continuous monitoring of the ongoing call, (ii) update decision logic using learned fraud patterns, (iii) present structured operation options to the user, and (iv) optionally take over the dialogue by an automated agent in a consistent, low-latency manner. As a result, the system cannot effectively control communication routing, cannot reliably support one-touch switching to an automated agent, and cannot provide an optimized human-machine interface for high-risk scenarios. From the standpoint of computer technology, these limitations manifest as inefficient processing pipelines, insufficient integration of speech recognition, generative analysis, and call control, and inadequate real-time responsiveness to dynamic conversational content.

Accordingly, there is a need for an improved computer-implemented system and server that can (1) acquire and process streaming audio in real time, (2) convert the audio into text and generate evaluation information for detecting fraudulent patterns, (3) systematically generate prompt sentences for a generative information processing model, (4) obtain machine-interpretable determination results and risk information, (5) continuously update such information over the full duration of a call, and (6) actively control both user notifications and automatic dialogue responses with a communication partner. Such a system should enhance the technical functioning of the underlying computer platform by providing an integrated, time-series fraud-detection and call-control pipeline that reduces latency, improves analysis accuracy, and yields predictable, structured outputs from a generative model suitable for further machine processing.

The specific processing by the specific processing unit 290 of the data processing device 12 in Application Example 1 is realized by the following means.

The present invention provides a server comprising a processor configured to acquire audio information and convert the audio information into text information, to analyze the text information to generate evaluation information for detecting patterns indicating a possibility of fraudulent activity in communication content, to generate a first prompt sentence to be input to a generative information processing model based on the evaluation information and the text information, to cause the generative information processing model, by using the first prompt sentence, to execute determination processing regarding a possibility of fraudulent activity and calculate risk information relating to the fraudulent activity from a determination result, to generate notification information including the risk information and warning information based on the determination result when the risk information satisfies a predetermined criterion and to transmit the notification information to a user information processing terminal, to continuously acquire audio information during an ongoing communication from the user information processing terminal and update the text information, the evaluation information, and the risk information in a time-series manner to continuously monitor a possibility of fraudulent activity over an entire duration of the communication, to cause the user information processing terminal, in response to the notification information, to provide operation information for receiving a user operation regarding continuation or termination of the communication, and to generate a second prompt sentence for automatically responding in place of a user in a dialogue with a communication partner in response to an instruction from the user information processing terminal and cause an audio response based on a response sentence generated by the generative information processing model using the second prompt sentence to be transmitted to the communication partner. This enables an integrated, computer-implemented pipeline in which streaming audio is converted into text, evaluated for fraud-related patterns, supplied to a generative model through structured prompt sentences, transformed into quantitative risk information, and used to drive real-time call-control and automated response functions, thereby improving system responsiveness, stability of model outputs, and overall effectiveness of fraud detection within the communication processing architecture.

The term “audio information” refers to information representing sound signals, including but not limited to voice signals captured during a communication session, typically expressed as analog or digital waveforms or encoded audio data.

The term “text information” refers to symbolic information obtained by converting audio information into a character-based representation, such as a sequence of characters, words, or sentences in a natural language.

The term “evaluation information” refers to machine-processable information generated by analyzing text information, the information indicating a likelihood, pattern, or feature associated with fraudulent activity in communication content.

The term “patterns indicating a possibility of fraudulent activity” refers to linguistic or contextual features in the communication content, including specific expressions, structures, or semantic cues, that are associated with known or predicted fraud scenarios.

The term “generative information processing model” refers to a computational model that, in response to input data, generates output information such as text, scores, or classifications, the model being trained on large amounts of data and capable of producing context-dependent responses.

The term “prompt sentence” refers to a sequence of text information provided as input to a generative information processing model, the sequence including instructions, context, and communication content to control the model's output behavior.

The term “determination processing regarding a possibility of fraudulent activity” refers to processing in which the generative information processing model, based on a prompt sentence, outputs information indicating whether the communication content is likely associated with fraudulent activity.

The term “risk information” refers to information derived from a determination result that quantitatively or qualitatively represents a degree of likelihood that fraudulent activity is occurring or will occur in the communication.

The term “notification information” refers to information generated for presentation to a user, the information including at least part of the risk information and optionally a warning message, explanation, or recommended action.

The term “user information processing terminal” refers to an electronic apparatus operated by a user, the apparatus including at least a communication interface, a display unit or an audio output unit, and an input interface, and being capable of sending and receiving data with a server.

The term “ongoing communication” refers to a communication session that is currently active between a user and a communication partner, including but not limited to a voice call or a voice-over-network session.

The term “time-series manner” refers to a processing mode in which data, including text information, evaluation information, and risk information, is updated in accordance with a temporal order of acquisition or occurrence, reflecting the chronological progression of a communication.

The term “warning information” refers to information indicating to a user that the communication has been evaluated as having a certain level of risk of fraudulent activity, the information being suitable for direct presentation by a user information processing terminal.

The term “operation information” refers to information that defines or enables one or more user interface elements through which a user can input an operation relating to control of the communication, including continuation, termination, or mode switching.

The term “response prompt sentence” refers to a prompt sentence specifically constructed to cause the generative information processing model to generate a response sentence to be used as an automated reply in a dialogue with a communication partner.

The term “response sentence” refers to text generated by the generative information processing model based on a response prompt sentence, the text being intended for conversion into an audio response or for presentation in another output form.

The term “audio response” refers to sound information generated by converting a response sentence into synthesized speech or other audio output suitable for transmission to a communication partner.

The term “communication partner” refers to an entity, such as a person or another system, that participates in a communication session with the user through the communication network.

The term “predetermined criterion” refers to a condition, threshold, or rule defined in advance, the condition being used to determine whether the risk information warrants generation and transmission of notification information.

The server, the terminal, and the user cooperate to implement the present invention. The server comprises at least one hardware processor, a main memory, a non-volatile storage device, a network interface, and optionally a hardware accelerator such as a graphics processing unit.

The terminal comprises at least one hardware processor, a memory, a wireless communication module, a microphone, a speaker, a display, and an input interface such as a touch panel or physical buttons.

The user operates the terminal during a voice communication with a communication partner.

The server executes an operating system and one or more application programs implementing functions of speech acquisition, speech-to-text conversion control, fraud-pattern evaluation, generative AI model control, risk aggregation, and call-control assistance.

The terminal executes an operating system such as a mobile device operating system and a communication application that can establish voice communication sessions and interact with the server over a data network.

The user initiates or receives a voice call using the terminal and may select an option to enable fraud monitoring and AI-assisted automatic response.

The server uses a speech-to-text software component implemented as an external cloud-based speech recognition service.

The server sends audio information received from the terminal to the speech recognition service and receives corresponding text information.

The server may use, as examples of such speech recognition services, a cloud speech-to-text application programming interface or an equivalent engine that accepts streaming audio and returns incremental transcription results with time stamps.

The terminal acquires raw audio signals from the microphone using an audio capture application programming interface and encodes them into a digital audio stream.

The terminal transmits the digital audio stream to the server over a secure transport channel, such as a transport layer security connection.

The server analyzes the text information using a fraud-pattern evaluation module that is configured as a trained neural network model or a combination of a neural network model and rule-based logic.

The server, in one embodiment, implements the fraud-pattern evaluation module as a bidirectional recurrent neural network or a transformer-based encoder that receives tokenized text as input and outputs a fraud-likelihood score and intermediate feature vectors representing semantic patterns.

The server stores the text information and evaluation information in a structured data store, such as a relational database table, where each entry includes a call identifier, a time index, a text segment, a local risk score, and model features.

The server uses a generative AI model as a large-scale language model.

The server, in one embodiment, accesses a generative AI model that is implemented as a multi-layer transformer network comprising an embedding layer, multiple self-attention layers, and a final output layer that produces a probability distribution over a vocabulary of tokens.

The server provides a prompt sentence to the generative AI model as a sequence of tokens including instructions, contextual metadata, and at least part of the transcribed conversation.

The server configures the generative AI model with parameters such as temperature, maximum number of generated tokens, and top-k or nucleus sampling settings to stabilize outputs for fraud-risk evaluation tasks.

The server converts the text information into tokens by using a subword tokenization algorithm such as byte pair encoding or a word-piece method.

The server computes attention weights across tokens in accordance with the transformer architecture to capture relationships between words and phrases indicative of fraud patterns, such as urgency of payment, secrecy, or references to family members in distress.

The server, during training of the fraud-pattern evaluation module or of a custom head on top of a pre-trained language model, uses supervised learning with a loss function such as cross-entropy loss.

The server updates model parameters by gradient-based optimization, such as stochastic gradient descent or an adaptive learning-rate method, to minimize the misclassification of training examples labeled as fraudulent or legitimate.

The server optionally uses data augmentation techniques, such as paraphrasing, synonym replacement, and back-translation, to generate additional training text sequences and improve robustness to linguistic variations.

The server generates evaluation information by processing the output of the neural network model.

The server maps the model's logits or probability values to a normalized risk score in a predetermined range, for example between 0 and 1.

The server stores this risk score, together with extracted features such as attention-based importance scores for certain tokens, as part of the evaluation information.

The server then uses this evaluation information, together with the text information, to construct a structured prompt sentence for the generative AI model.

The server, in one embodiment, generates a prompt sentence such as:
“The following is a phone conversation. You are a fraud-detection assistant. Check if the caller may be attempting a special fraud. Answer only in English with ‘fraud likely’ or ‘fraud unlikely’ and then give a short explanation. Conversation: [TRANSCRIBED TEXT HERE].”

The server, in another embodiment, generates a prompt sentence such as:
“Please classify whether the following phone conversation is likely to be a fraud attempt. Answer only with ‘fraud likely’ or ‘fraud unlikely’ and then give one short reason. Conversation: [TRANSCRIBED TEXT HERE].”

The server, in a further embodiment where user advice is also needed, generates a prompt sentence such as:
“You are a security advisor. Read the following phone conversation and determine if it is likely to be a fraud. First output ‘fraud likely’ or ‘fraud unlikely’, and then provide brief advice to the user in simple language. Conversation: [TRANSCRIBED TEXT HERE].”

The server uses these prompt sentences to obtain structured, machine-interpretable outputs from the generative AI model, thereby enabling the processor to reliably convert textual responses such as “fraud likely” into quantitative risk information and system control commands.

The server integrates the generative AI model into a modular architecture.

The server, in one embodiment, comprises a speech processing module, a text storage module, a fraud-pattern evaluation module, a prompt generation module, a generative-model interface module, a risk aggregation module, and a notification control module.

The speech processing module handles low-latency streaming of audio data from the terminal and invokes the speech recognition service.

The text storage module maintains a rolling buffer of recent transcriptions in a ring buffer structure, enabling efficient access to the latest N utterances for prompt construction.

The fraud-pattern evaluation module computes local scores for each utterance.

The risk aggregation module computes a moving average or weighted sum of risk scores over a configurable time window, thereby smoothing noise and reducing false spikes.

The notification control module compares the aggregated risk measure against a threshold and triggers notifications when appropriate.

The terminal receives notification information from the server.

The terminal, upon receiving such notification, displays a warning banner on the display, plays an alert sound through the speaker, and may activate vibration hardware.

The terminal draws user-interface components such as buttons labelled “Hang up” and “Continue with caution” using the operating system's graphical user interface toolkit.

The user, in response to the notification, may tap one of these buttons.

The terminal, based on the user's selection, either sends a termination request to the telephony subsystem or maintains the communication session.

The terminal also sends an indication of the user's selected action back to the server for logging and for potential refinement of decision thresholds or prompt sentence templates.

The server provides an option for the user to enable automatic AI-based response.

The terminal, when the user activates this option, sends an instruction message to the server.

The server, in response to this instruction, generates a response prompt sentence designed for generating a reply to the caller, for example:
“You are an AI call assistant protecting a vulnerable user from fraud. Reply in polite language to the caller. Ask for detailed information and avoid sharing any personal or financial data. Maintain a calm and neutral tone. Caller said: [TRANSCRIBED TEXT HERE]. Generate the next AI response sentence.”

The server provides this response prompt sentence to the generative AI model and obtains a response sentence.

The server then converts the response sentence into an audio response using a text-to-speech engine, which may be provided by a cloud-based text-to-speech service or a local synthesis library.

The server streams the synthesized audio to the terminal.

The terminal plays the synthesized audio through the speaker so that the communication partner hears the AI-generated response.

The user monitors the conversation on the display, which may show both the caller's statements and the AI's responses as text.

The server achieves specific technical improvements over conventional systems by integrating speech recognition, time-series fraud-pattern evaluation, generative model prompting, and call-control feedback into a unified, low-latency pipeline.

The server reduces processing latency by using streaming speech recognition and incremental transcription, thereby avoiding full-call buffering.

The server improves detection accuracy by combining a specialized fraud-pattern evaluation module with a generative AI model that operates on carefully structured prompt sentences, instead of relying solely on simple keyword lists.

The server, by maintaining a time-indexed data structure of text information and evaluation information, efficiently reuses context and avoids redundant analysis, which improves computational efficiency and reduces processing load.

The server's risk aggregation module, by applying time-windowed smoothing and thresholding, reduces transient false positives and stabilizes system behavior.

The server improves data management by storing conversation segments, risk scores, prompt sentences, and model outputs in normalized database tables or key-value stores with indexes on call identifiers and timestamps.

The server can thereby quickly retrieve recent context segments for prompt generation, which contributes to lower latency and more contextually coherent inputs to the generative AI model.

The server can also adjust threshold parameters and model hyperparameters dynamically based on aggregate performance statistics, such as detection rate and false-positive rate recorded in logs.

The server uses processing strategies that are not merely an automation of human analysis.

The server computes vector embeddings and attention distributions that humans cannot explicitly compute in real time, thereby capturing high-dimensional semantic patterns across long conversations.

The server applies non-intuitive rules, such as weighting recent utterances more heavily than older ones in risk aggregation, or selectively masking user-identifiable content before sending the text to the generative AI model to preserve privacy while retaining fraud-relevant semantics.

The server can also use distinct prompt sentence templates depending on the stage of the conversation, such as early-stage=screening prompts and late-stage confirmation prompts, which enables graded responses from the generative model.

The server's internal training process further contributes to technical improvements.

The server uses labeled datasets that include transcripts of genuine calls and fraud attempts.

The server tokenizes each transcript, extracts features such as occurrence of particular phrase patterns and temporal position of requests for money, and trains the fraud-pattern evaluation module to output accurate risk scores.

The server defines an objective function that penalizes both missed fraud detections and false alarms, thereby optimizing for a balance appropriate to deployment constraints.

The server performs model validation by cross-validation and can periodically retrain or fine-tune the model using newly collected data included in the logs, thereby adapting to evolving fraud techniques.

The server also supports multiple embodiments.

In one embodiment, the server executes all neural network computations on a remote cloud infrastructure with graphics accelerators, and the terminal merely streams audio and displays results.

In another embodiment, the terminal locally executes a lightweight fraud-pattern evaluation module, such as a compact recurrent network, to pre-filter calls, and only high-risk segments are forwarded to the server for detailed generative model analysis, thereby reducing communication bandwidth and server load.

In a further embodiment, the server deploys the generative AI model partially on-premise in a private data center for environments with strict privacy requirements, while still using a public cloud speech-to-text service.

The server, by integrating the above-described components and algorithms, achieves improved processing speed, improved detection precision, and reduced computational overhead compared with naive implementations that would, for example, send entire raw audio recordings to a generic speech-to-text and language model pipeline without time-series risk management or targeted prompting.

The terminal, by providing real-time user interface elements synchronized with the server's risk evaluations, enables effective human intervention at appropriate times without requiring constant attention from the user.

The user, by interacting with the terminal and optionally delegating part of the conversation to the AI-based response function, can benefit from an enhanced protection system that is realized through specific improvements in computer-implemented communication processing, model control, and data flow management.

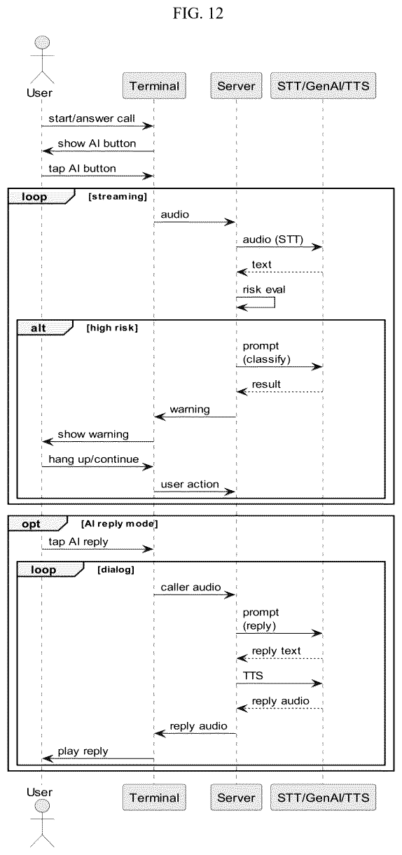

The following describes the processing flow using FIG. 12.

Step 1:

The user starts or answers a voice call using the terminal.

The terminal receives, as input, a call control event from the operating system's telephony function (for example, “incoming call accepted”).

The terminal outputs a call session identifier and an active call state to its communication application.

The terminal displays, on the screen, an in-call user interface that includes a button to enable AI-based fraud monitoring.

Step 2:

The user enables AI-based fraud monitoring by pressing the corresponding button on the terminal.

The terminal receives, as input, the user's touch event on the AI-monitoring button.

The terminal sets an internal monitoring flag and outputs a monitoring-enabled message containing the call session identifier to the server via a secure data channel.

The terminal updates the user interface to indicate that fraud monitoring is active.

Step 3:

The terminal captures call audio and sends it to the server.

The terminal receives, as input, raw audio samples from the microphone through an audio capture application programming interface.

The terminal performs data processing by encoding the raw audio samples into a compressed digital audio stream (for example, pulse-code modulation or a low-bit-rate codec) and packetizing the stream with time stamps and the call session identifier.

The terminal outputs the encoded audio packets to the server over a network connection.

Step 4:

The server receives and buffers the audio packets.

The server receives, as input, the encoded audio packets and the associated call session identifier from the terminal.

The server performs data processing by decoding the audio packets if needed, ordering them by time stamp, and storing them in a buffer structure keyed by the call session identifier.

The server outputs buffered audio segments of a predetermined duration (for example, several seconds) for further processing.

Step 5:

The server converts the buffered audio segments into text information.

The server receives, as input, an audio segment from the buffer and configuration parameters such as language code and sampling rate.

The server performs data processing by calling a speech-to-text processing module or an external speech recognition service, transmitting the audio segment, and receiving a transcription result.

The server outputs text information representing the recognized utterance, together with time stamps and a confidence score.

Step 6:

The server stores and structures the text information for time-series analysis.

The server receives, as input, the text information, the call session identifier, and the associated time stamps.

The server performs data processing by inserting a record into a data structure or database table, where each record includes the call session identifier, a segment index, the text information, and the recognition confidence.

The server outputs an updated conversation log that accumulates multiple text segments in chronological order.

Step 7:

The server evaluates each new text segment for local fraud patterns.

The server receives, as input, the latest text segment from the conversation log.

The server performs data processing by tokenizing the text segment into tokens, feeding the tokens to a fraud-pattern evaluation module (for example, a neural network classifier), and computing a local risk score and feature vector.

The server outputs evaluation information including the local risk score and pattern features associated with the text segment.

Step 8:

The server aggregates risk information over a time window.

The server receives, as input, a sequence of recent local risk scores related to the call session identifier.

The server performs data processing by applying a mathematical aggregation method, such as computing a moving average, a weighted sum, or a maximum value over the specified time window, and optionally applying smoothing or normalization functions.

The server outputs an aggregated risk score that represents the current overall likelihood of fraudulent activity during the ongoing call.

Step 9:

The server determines whether the aggregated risk score exceeds a predetermined criterion.

The server receives, as input, the aggregated risk score and a stored threshold value for fraud detection.

The server performs data processing by comparing the aggregated risk score with the threshold and generating a binary or multi-level decision (for example, “no alert,” “moderate risk,” or “high risk”).

The server outputs a decision flag indicating whether a warning condition is satisfied and, if satisfied, a risk level classification.

Step 10:

The server constructs a prompt sentence for the generative AI model when an evaluation is needed.

The server receives, as input, a selection of recent text segments from the conversation log and the corresponding evaluation information.

The server performs data processing by concatenating the text segments into a coherent conversation excerpt, embedding them into a template that includes instructions and expected output format, and replacing placeholders with the actual conversation text.

The server outputs a prompt sentence such as:
“Please classify whether the following phone conversation is likely to be a fraud attempt. Answer only with ‘fraud likely’ or ‘fraud unlikely’ and then give one short reason. Conversation: [TRANSCRIBED TEXT HERE].”

Step 11:

The server sends the prompt sentence to the generative AI model and receives a generated response.

The server receives, as input, the prompt sentence and configuration parameters such as temperature and maximum output length.

The server performs data processing by converting the prompt sentence into tokens using a tokenizer, transmitting the token sequence to the generative AI model, and executing the model's forward computation to generate an output token sequence.

The server outputs a generated text response containing at least a classification phrase (for example, “fraud likely”) and an explanatory sentence.

Step 12:

The server interprets the generative AI model's response and updates risk information.

The server receives, as input, the generated text response.

The server performs data processing by parsing the response to extract the classification term and explanation, mapping the classification to a numerical value, and combining this value with the previously aggregated risk score using a weighting or fusion algorithm.

The server outputs updated risk information that reflects both the fraud-pattern evaluation module and the generative AI model's classification result.

Step 13:

The server decides whether to issue a warning to the terminal based on the updated risk information.

The server receives, as input, the updated risk information and a second threshold or policy rules defining when to notify the user.

The server performs data processing by evaluating logical conditions, such as whether the updated risk score is above the threshold or whether the risk has increased rapidly during a recent interval.

The server outputs a notification trigger signal and associated warning content if the conditions are satisfied.

Step 14:

The server generates notification information including warning details.

The server receives, as input, the notification trigger signal, the updated risk information, and the explanation extracted from the generative AI model's output.

The server performs data processing by assembling a structured message that includes a risk level, a warning text, a concise reason, and recommended user actions such as “terminate the call” or “verify the caller's identity,” and attaches the call session identifier.

The server outputs notification information formatted for transmission to the terminal.

Step 15:

The server transmits the notification information to the terminal.

The server receives, as input, the notification information and the network address or session parameters of the terminal.

The server performs data processing by encoding the notification into a suitable message format, such as a lightweight object notation or protocol message, and sending it through a push notification service or an existing data channel.

The server outputs a network message that, when received by the terminal, triggers a local warning display.

Step 16:

The terminal receives and presents the warning to the user.

The terminal receives, as input, the notification information from the server.

The terminal performs data processing by verifying that the call session identifier matches the current active call, parsing the warning text and recommended actions, and constructing a user interface view containing this information.

The terminal outputs a visual alert on the display, optionally accompanied by an audio alert through the speaker and a vibration pattern.

Step 17:

The user reacts to the warning and selects an operation.

The user receives, as input, the visual and audio indications provided by the terminal.

The user performs cognitive processing to understand that the call may be fraudulent and then selects an operation by tapping a button such as “Hang up” or “Continue with caution” on the display.

The user outputs, via the touch input, a command that indicates the desired action to the terminal.

Step 18:

The terminal executes the user's selected operation and informs the server.

The terminal receives, as input, the user's button press event and the associated command type.

The terminal performs data processing by mapping the command type to a telephony control instruction, such as “terminate call,” and invoking the operating system's telephony interface to apply the instruction, while also creating a summary of the user's decision.

The terminal outputs, to the server, a response message containing the call session identifier and the user's chosen action, and, in the case of termination, ends the call.

Step 19:

The user optionally activates AI-based automatic response mode.

The user receives, as input, an indication on the terminal that an AI response mode is available, for example, a button labelled “AI answer for me.”

The user performs a selection by tapping this button during the call.

The user outputs, via the touch interface, a request that the AI system respond to the caller on the user's behalf.

Step 20:

The terminal adjusts audio routing for automatic response mode.

The terminal receives, as input, the user's request for AI-based automatic response.

The terminal performs data processing by updating audio routing parameters so that the microphone input is primarily directed to the server for AI processing, and the user's microphone may be muted or reduced in gain for the communication partner, while maintaining playback of both the caller's and AI's audio to the user.

The terminal outputs updated audio routing settings and an instruction message to the server indicating that AI response mode is active.

Step 21:

The server generates a response prompt sentence for the generative AI model.

The server receives, as input, the most recent caller utterance text, the current conversation context, and the indication that AI response mode is active.

The server performs data processing by selecting an appropriate prompt template for AI responses, inserting the caller's text and possibly previous turns into the template, and generating a response-oriented prompt sentence such as:
“You are an AI call assistant protecting a vulnerable user from fraud. Reply in polite language to the caller. Ask for detailed information and avoid sharing any personal or financial data. Maintain a calm and neutral tone. Caller said: [[TRANSCRIBED TEXT HERE] [symbol] . Generate the Next AI Response Sentence.”

The server outputs the response prompt sentence ready for submission to the generative AI model.

Step 22:

The server obtains a response sentence from the generative AI model.

The server receives, as input, the response prompt sentence and the current model configuration parameters.

The server performs data processing by tokenizing the response prompt sentence, feeding the token sequence through the generative AI model to compute attention layers and output token probabilities, and sampling or decoding the output sequence according to the configured strategy.

The server outputs a response sentence in text form that is suitable for being spoken to the communication partner.

Step 23:

The server converts the response sentence into an audio response and sends it to the terminal.

The server receives, as input, the response sentence.

The server performs data processing by providing the response sentence to a text-to-speech synthesis engine, which converts the text to a digital audio waveform, and by encoding the waveform into a stream format suitable for real-time playback.

The server outputs the encoded audio response stream to the terminal over the established network connection.

Step 24:

The terminal plays the AI-generated audio response to the communication partner.

The terminal receives, as input, the encoded audio response stream from the server.

The terminal performs data processing by decoding the audio stream, buffering it appropriately to avoid jitter, and sending it to the speaker output path that is connected to the communication channel with the communication partner.

The terminal outputs the synthesized speech through the speaker, so that the communication partner hears the AI-generated reply while the user listens and observes the ongoing interaction.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional fraud detection techniques for telecommunication sessions typically rely on static keyword lists, fixed pattern matching rules, or offline analysis performed after a call has ended. Such techniques often suffer from high false positive rates, delayed detection, and an inability to adapt to evolving fraud scenarios. In particular, when call audio is processed using batch-oriented pipelines, intermediate artifacts such as partial transcripts, model scores, and user responses are not consistently correlated in real time, which hinders timely and accurate intervention on an ongoing call.

Moreover, known systems that utilize machine learning or natural language processing frequently treat speech recognition, text analysis, and user notification as isolated components. These systems generally lack a coordinated mechanism that (i) incrementally constructs structured text representations aligned with temporal information in a call, (ii) dynamically builds and updates a prompt sentence for a generative AI model based on the current conversational context, and (iii) feeds back user behavior to refine fraud detection criteria. As a result, the underlying computer system does not fully optimize its resource usage, model invocation strategy, or decision thresholds, and therefore does not achieve robust, low-latency fraud detection in a networked environment.

In addition, generative AI models are typically used in a generic chat or question-answering mode without explicit constraints tailored to special fraud detection. Without a specialized prompt construction mechanism that encodes domain-specific criteria, output formats, and contextual metadata such as call direction and speaker roles, the model's responses can be inconsistent, difficult to integrate into automated decision logic, and computationally inefficient. This leads to suboptimal utilization of generative AI capabilities within the system, and may even cause the system to ignore or misinterpret subtle fraud patterns that emerge progressively in a conversation.

Furthermore, existing systems rarely store, in a unified and structured manner, the determination results from a generative AI model, associated risk indices, notification events, and post-notification user actions. The absence of such an integrated feedback loop prevents the system from programmatically tuning prompt design, thresholds, and model selection based on real-world performance data. Consequently, the computing architecture cannot evolve in a data-driven way to reduce false alarms, improve recall for new fraud schemes, and optimize the balance between detection accuracy and processing overhead.

Accordingly, there is a need for an improved computer-implemented system that performs real-time capture and structured transcription of call audio, constructs and updates a fraud-oriented prompt sentence for a generative AI model using temporally segmented and annotated text data, computes and records risk indices based on multiple AI determinations, and adjusts its own fraud detection logic and prompt configuration according to historical user interaction and outcome data. Such a system would provide a technical improvement in the way computer resources are orchestrated for fraud detection during communication sessions, enabling more accurate, timely, and adaptive protection of users while optimizing the behavior of the underlying computing infrastructure.

The specific processing by the specific processing unit 290 of the data processing device 12 in Example 2 is realized by the following means.

The present invention provides a server comprising a processor configured to acquire call audio data from a communication apparatus, associate the call audio data with communication information including time information and user identification information, and store the associated data as structured call records; to transmit the call audio data to a speech recognition resource, receive character string information generated by speech recognition, and integrate the character string information based on the time information to generate text data; to construct a prompt sentence for a generative AI model by dividing the text data into segments of a predetermined length in accordance with call progress, adding call direction information, speaker distinction information, and call section information to the segments, and embedding, in the prompt sentence, criteria for determining special fraud and a predefined output format together with at least part of the text data; to input the prompt sentence into the generative AI model, obtain a plurality of determination results regarding a possibility of fraud, and integrate the determination results to calculate a risk index; to determine, based on the risk index, whether a predetermined criterion is satisfied, and store, in association with each other, the determination results, the risk index, and warning information as part of the call records; to generate and transmit notification information including the warning information to the communication apparatus so as to cause the communication apparatus to perform a warning display or a warning operation when the predetermined criterion is satisfied; and to further store, in association with the call records, operation information indicating a call termination operation or a rejection operation by a user and to update at least one of conditions for constructing the prompt sentence and the predetermined criterion based on the stored call records and operation information. This enables the computer system to perform real-time, context-aware fraud detection on ongoing calls by orchestrating speech recognition, structured text segmentation, domain-specific prompt generation for a generative AI model, and adaptive threshold control, thereby improving detection accuracy, reducing latency, and automatically tuning fraud detection behavior based on accumulated user interaction and model performance data.

The term “call audio data” refers to digital audio information representing voice signals exchanged during a communication session between a caller and a callee.

The term “communication apparatus” refers to an electronic device configured to send and receive audio or data in a communication network, including but not limited to a mobile terminal, a fixed-line telephone terminal, or a software-based communication client.

The term “time information” refers to data indicating temporal attributes of events in a call, such as timestamps, time intervals, or time offsets corresponding to portions of the call audio data or text data.

The term “user identification information” refers to data that distinguishes one user from another within the system, including but not limited to user identifiers, account identifiers, device identifiers, or subscription identifiers.

The term “communication information” refers to metadata associated with a communication session, including at least time information and user identification information, and optionally including call direction, call type, or network-related parameters.

The term “structured call records” refers to stored data objects that include call audio data or text data and associated communication information, organized in a predefined format suitable for retrieval, analysis, and correlation.

The term “speech recognition resource” refers to a hardware or software component, or a combination thereof, configured to convert call audio data into character string information, including but not limited to a speech recognition engine or a cloud-based speech recognition service.

The term “character string information” refers to textual data output by the speech recognition resource that represents recognized words or phrases corresponding to portions of the call audio data.

The term “text data” refers to integrated character string information obtained from the speech recognition resource, arranged and normalized based on time information so as to represent at least a part of the content of a call in textual form.

The term “generative AI model” refers to an information processing model that generates output content, such as natural language text, based on input data, and that possesses natural language processing capabilities sufficient to evaluate semantic context and produce determination results regarding fraud.

The term “prompt sentence” refers to a structured input sequence provided to the generative AI model, including instructions, criteria, formatting requirements, and at least part of the text data, designed to cause the generative AI model to output a determination result in a predetermined form.

The term “criteria for determining special fraud” refers to rule-like conditions or guidelines encoded in the prompt sentence or in system logic, specifying phrases, patterns, or contextual indicators used to assess whether a conversation is likely associated with fraudulent activity.

The term “output format” refers to a predefined structure for responses from the generative AI model, including but not limited to a label, a numerical score, and an explanatory portion, enabling deterministic parsing and subsequent processing by the system.

The term “segments of a predetermined length” refers to portions of the text data obtained by dividing the text data according to a defined unit, such as a number of characters, tokens, or time-based intervals, to facilitate stepwise analysis by the generative AI model.

The term “call direction information” refers to metadata indicating whether a call is incoming or outgoing for a given user or communication apparatus.

The term “speaker distinction information” refers to data identifying different speakers in a call, such as a caller and a callee, or multiple participants, and associating segments of text data with corresponding speakers.

The term “call section information” refers to data that classifies portions of a call into sections, such as an opening section, a middle section, or a closing section, based on temporal position or dialog structure.

The term “determination result” refers to information output by the generative AI model in response to a prompt sentence, indicating at least whether there is a possibility of fraud in the analyzed text data.

The term “risk index” refers to a quantitative or qualitative value computed from one or more determination results to represent a degree of likelihood or severity of fraud associated with a call.

The term “predetermined criterion” refers to a threshold or condition applied to the risk index or the determination result to decide whether the system should treat a call as potentially fraudulent and trigger further actions such as notification.

The term “warning information” refers to data representing an alert or caution message indicating that a call may be fraudulent, including textual, auditory, or visual elements intended for presentation to a user.

The term “notification information” refers to a data payload transmitted from the server to the communication apparatus, including at least warning information and optional context information, used to cause the communication apparatus to perform a warning display or a warning operation.

The term “warning display” refers to a presentation of warning information on a user interface of the communication apparatus, such as a pop-up window, banner, or icon, indicating the possibility of fraud in a call.

The term “warning operation” refers to an action performed by the communication apparatus in response to notification information, including but not limited to displaying a warning, generating a vibration, emitting a sound, or highlighting a call control element.

The term “operation information” refers to data representing actions performed by a user with respect to a call, including but not limited to a call termination operation, a call rejection operation, or selection of a user interface control related to fraud reporting or call blocking.

The term “conditions for constructing the prompt sentence” refers to rules, parameters, or templates used by the server to determine how to compose the prompt sentence, including which segments of text data to include, which criteria for determining special fraud to reference, and which output format to request.

The term “call termination operation” refers to an operation by which a user actively ends an ongoing call, such as pressing an end-call button or issuing a command to disconnect.

The term “rejection operation” refers to an operation by which a user refuses or cancels an incoming call, such as declining the call through a user interface of the communication apparatus.

The term “call records” refers to aggregated data sets that include structured call records, determination results, risk indices, notification events, and operation information, enabling historical analysis and adaptive adjustment of system behavior.

In one embodiment, a server cooperates with one or more terminals to implement a real-time fraud detection system for voice communications. The server includes at least one processor, a memory storing executable instructions and data structures, and a network interface connected to a communication network. The terminal includes audio input hardware, a display unit, a vibration unit, and a network communication module. The user uses the terminal to conduct a call, and the terminal and the server jointly process audio signals, text data, and fraud risk information according to the following configurations.

The terminal acquires call audio data using a microphone and an audio subsystem provided by an operating system such as a mobile operating system or a desktop operating system. The terminal converts analog voice signals into digital samples using an analog-to-digital converter and an audio driver. The terminal optionally encodes the audio samples using a voice codec such as a waveform codec or a compression codec and transmits the encoded data to the server through a secure communication protocol, for example, transport layer security over a packet-switched network. The terminal attaches communication information such as time information and user identification information as metadata to the audio stream.

The server receives the call audio data via the network interface and stores the audio stream in a buffer structure in the memory. The server associates the audio stream with communication information including time information (for example, timestamps and time offsets), user identification information (for example, user identifiers or device identifiers), and call identification information. The server records these associations as structured call records in a persistent data store such as a relational database system or a key-value store.

The server thus maintains a data structure in which each call is represented by a call identifier, one or more audio segments, and corresponding metadata including time ranges and user identifiers.

The server uses a speech recognition resource to convert call audio data into character string information. The speech recognition resource can be implemented as a local software library running on the server, or as an external service accessible via an application programming interface. For example, the server can use a generic speech-to-text engine that applies an acoustic model and a language model to the incoming audio to generate partial and final transcripts. The server supplies buffered audio segments to the speech recognition resource in sequence and receives recognition results that include recognized text, time offsets, and confidence scores. The server integrates multiple recognition outputs by aligning them based on the time offsets and the is-final flags provided by the recognizer, and the server generates text data that represents at least a part of the call in chronological order.

The server normalizes the text data by performing text processing operations such as character normalization, punctuation insertion, number normalization, and segmentation. The server may use text processing libraries or regular expression engines to remove duplicate fragments, merge overlapping segments, and unify different character variants. The server divides the normalized text data into segments of a predetermined length. The predetermined length can be defined as a number of characters, a number of tokens, or a time interval. The server further annotates each segment with call direction information (incoming or outgoing), speaker distinction information (for example, caller or callee), and call section information (for example, opening section, middle section, or closing section). The server stores each segment together with these annotations in a segment list associated with the call record.

The server constructs a prompt sentence to be input into a generative AI model having natural language processing functionality. The generative AI model can be implemented as a transformer-based neural network with an encoder-decoder architecture or a decoder-only architecture. The model typically consists of multiple attention layers, feed-forward layers, and normalization layers. The server passes a tokenized version of the prompt sentence to the generative AI model through an inference interface. The generative AI model receives token sequences as input and produces output token sequences corresponding to a determination result regarding a possibility of fraud.

The server composes the prompt sentence by combining several elements: instructions to the generative AI model, criteria for determining special fraud, a predefined output format, and one or more text segments annotated with metadata. The server can, for example, include in the prompt sentence the following type of instruction:
“The server analyzes the following call transcript and determines whether there is a possibility of a special fraud attempt. The server focuses on requests for bank account information, urgent money transfers, card numbers, or suspicious instructions. The server returns a JSON-like structure in text form with fields ‘label’ (‘fraud’ or ‘no_fraud’), ‘risk_score’ (0.0-1.0), and ‘reason’ (short explanation in English).

Transcript:

[here the server inserts the annotated segments of the call transcript in chronological order].”

In another example, the server uses a more explicit constraint on the output:
“The server is a fraud-detection component. The server receives a transcript of a phone call between a caller and a user. The server must detect special fraud patterns commonly used in phone scams (for example, pretending to be a financial institution, a law enforcement authority, or a tax authority; asking for account numbers, personal identification numbers, or urgent money transfers).

Task:
1. Read the transcript carefully.
2. Decide whether this call is likely to be a fraud attempt.
3. Output only the following single line:
label=[fraud or no_fraud]; risk_score=[0.0-1.0]; reason=[short explanation in English].

Transcript:

[here the server inserts a portion of the text data corresponding to the most recent part of the call].”

The server optionally includes examples of fraudulent and non-fraudulent patterns in the prompt sentence. By doing so, the server performs a few-shot learning configuration, which assists the generative AI model in differentiating between normal customer support calls and suspicious calls that contain subtle cues of fraud. The server also ensures that the length of the prompt sentence, after tokenization, does not exceed a context window size of the model.

The server can drop or summarize older segments when the conversation becomes long, thereby maintaining computational efficiency and stable model latency.

The generative AI model internally executes a sequence of operations on the input tokens.

The model converts each token into an embedding vector, applies multiple attention layers to compute context-aware representations, and processes these representations through feed-forward networks to obtain output logits for each output token. The server configures inference parameters such as temperature, top-k sampling, or nucleus sampling to bias the generative AI model toward deterministic and structured outputs suitable for fraud detection.

The server can also constrain the output space by enforcing patterns in the decoding stage, for example by relying on a constrained decoding mechanism that only allows tokens compatible with the specified output format.

The server parses the output of the generative AI model to obtain a determination result, which includes at least a label indicating whether fraud is suspected, a risk index in the form of a numerical score, and a reason in natural language. When the generative AI model directly outputs a structured line such as:
“label=fraud; risk_score=0.87; reason=Caller urgently requests bank account number and immediate transfer to a ‘safe account’.”
the server extracts the numerical value 0.87 as the risk index, extracts “fraud” as the label, and associates this information with the corresponding call record and text segments.

The server calculates a final risk index for the call by aggregating determination results obtained from multiple prompt sentences corresponding to different segments or time intervals. The server can use a weighted average where more recent segments are assigned higher weights, or a maximum operator where the highest risk index among all segments is used as the final index. The server can further adjust the risk index by applying rule-based modifiers, for example increasing the risk index when specific high-risk phrases or patterns are detected, or decreasing the risk index when explicit safety confirmations are found. The server stores the per-segment determinations and the aggregate risk index as part of the call record.

The server compares the risk index with a predetermined criterion. The predetermined criterion can be a threshold value stored in a configuration table. When the risk index exceeds the threshold, the server determines that the call has a high possibility of fraud. The server then generates warning information in a natural language, such as “There is a possibility of fraud. Please be careful. Do not provide your account number or transfer money during this call.” The server constructs notification information including the warning information, the call identifier, the risk index, and optional recommended actions. The server transmits the notification information to the terminal as a push notification, a signaling message, or an in-call control message.

The terminal receives the notification information through a communication interface and decodes the message. The terminal displays the warning information on a display unit, for example as a pop-up dialog overlaid on the call screen. The terminal may also activate the vibration unit or play an alert tone using its audio subsystem. In some embodiments, the terminal highlights an “End Call” button or presents additional user interface elements such as “Block this number” or “Report this call.” The terminal thus performs a warning display or a warning operation in direct coordination with the server's detection result.

The user perceives the warning and may terminate the call by selecting the “End Call” button or by issuing a voice command. The terminal records the user's operation as operation information, such as “user terminated call after warning” or “user ignored warning and continued call.” The terminal transmits the operation information back to the server. The server associates the operation information with the corresponding call record, and the server stores the combined data, including determination results, risk indices, warning information, and operation information, as historical data for model performance analysis.

The server uses historical call records to adjust conditions for constructing the prompt sentence and to update the predetermined criterion. For example, the server can compute statistics on false positives and false negatives by comparing generated labels and risk indices with user behavior patterns, such as immediate call termination or repeated complaints. The server may then lower the threshold when the system misses many confirmed fraudulent calls, or increase the threshold when many warnings are ignored without any negative consequence. The server can also refine the criteria for determining special fraud by increasing weights for particular phrase patterns that frequently appear in confirmed fraud cases. The server updates these parameters in its memory and configuration store without changing client behavior on the terminal, resulting in a server-side evolution of the detection capabilities.

The server can further retrain or fine-tune the generative AI model or an auxiliary classifier using the collected call records. The server selects a subset of call transcripts and associated labels derived from user outcomes. The server uses a supervised learning procedure in which the model's output is compared with target labels, a loss function such as cross-entropy loss is computed, and weight parameters are updated through gradient-based optimization. The server can employ data augmentation techniques such as paraphrasing or noise injection to expand the training set. By conducting periodic retraining, the server adapts the internal parameters of the neural network to new fraud patterns and improves prediction accuracy.

The described configuration provides technical effects that go beyond mere automation of human judgment. The server reduces computational load and network latency by performing incremental segmentation of text data and by limiting the context passed to the generative AI model to recent, high-relevance segments. This segmentation reduces the number of tokens processed by the model, thereby lowering inference time and memory usage. The server simultaneously improves detection accuracy by incorporating structured metadata (call direction, speaker distinction, call section) as contextual information in the prompt sentence, enabling the generative AI model to differentiate between similar phrases occurring in different roles or stages of a call.

Furthermore, the integration of speech recognition results with time information and user identification information in structured call records enables efficient indexing and retrieval.

The server can quickly correlate fraud detection results with specific temporal portions of a call, which facilitates targeted re-analysis or investigation. The system thus improves data management and computation efficiency compared with unstructured logging approaches.

The use of explicit output formats and constrained decoding ensures that the generative AI model produces outputs that can be deterministically parsed by the server, which reduces error rates in downstream decision logic. The server thereby achieves a reduced number of ambiguous or unusable outputs compared with generic conversational deployments of large language models. Additionally, the feedback loop from user operation information to prompt configuration and threshold adjustment creates a self-optimizing architecture. The server programmatically updates its own decision-making parameters based on performance metrics—such as true positive rate, false positive rate, and user-initiated terminations—leading to continuous improvement in detection performance without manual rule engineering.

In another embodiment, the server uses a hybrid architecture that combines a generative AI model with a conventional classifier. The server first applies a feature extraction process to the text data, computing features such as n-gram statistics, keyword presence, part-of-speech patterns, and discourse markers. The server feeds these features into a trained classification model such as a gradient boosting machine or a feed-forward neural network to obtain an initial fraud risk score. The server then includes this score as part of the prompt sentence given to the generative AI model. In this way, the generative AI model receives not only raw text but also structured features, which allows the model to perform a more nuanced contextual evaluation. The server aggregates the outputs of both models to obtain the final risk index. This hybrid approach reduces the frequency of invoking the generative AI model for obviously safe or obviously fraudulent cases, thereby lowering computation cost and improving system throughput.

In yet another embodiment, the terminal performs part of the processing locally, for example, by running a lightweight speech recognizer or a small-scale fraud classifier. The terminal can pre-filter calls and only forward audio segments that satisfy certain heuristic conditions (for example, presence of specific high-risk phrases) to the server for further analysis by the generative AI model. This configuration reduces network traffic and server load, which is particularly beneficial in environments with limited bandwidth or high concurrency. Even in this case, the server remains responsible for constructing the detailed prompt sentence, orchestrating the generative AI model, and managing the feedback loop based on historical call records.

By combining these configurations, the server improves the functioning of the underlying computer system as a whole. The system processes voice communications in real time, uses structured data flows and segmented prompt sentences to control a generative AI model, and adaptively tunes its detection behavior based on stored call records and user interactions. As a result, the server achieves enhanced processing speed, improved detection precision, reduced error rates, and optimized resource usage in comparison with conventional systems that rely on static keyword lists or monolithic analysis of entire call transcripts.

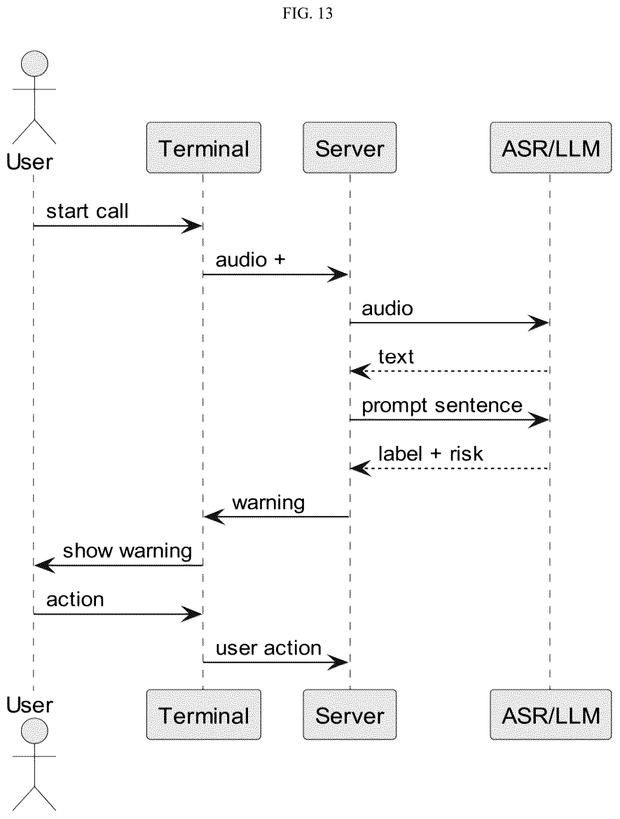

The following describes the processing flow using FIG. 13.

Step 1:

The terminal acquires call audio data from the user.

The terminal uses a microphone and an audio driver provided by an operating system to sample the user's voice and the remote party's voice and converts analog signals into digital pulse code modulation samples.
Input: analog voice signals from the user and the remote party.
Processing: the terminal performs analog-to-digital conversion, segments the samples into frames, optionally encodes the frames using a codec, and attaches metadata such as user identification information and time information.
Output: digital call audio data with associated metadata ready to be transmitted to the server.

Step 2:

The terminal transmits the call audio data and metadata to the server.

The terminal establishes a secure network connection to the server and sends audio frames as a continuous stream or batched packets while the call is active.
Input: encoded or raw call audio data and metadata including user identification information and time information.
Processing: the terminal packages the audio data and metadata into network messages according to a communication protocol and manages retransmission or buffering in case of network delay.
Output: network messages containing call audio data and metadata delivered to the server.

Step 3:

The server receives and buffers the call audio data from the terminal.

The server accepts incoming network messages via a network interface and stores the payloads in a memory buffer associated with a call identifier.
Input: network messages containing call audio data and metadata.
Processing: the server parses the network messages, extracts the audio frames and metadata, validates the user identification information, and appends the frames to a buffer keyed by the call identifier and time information.
Output: buffered call audio data and structured call records containing communication information in the server memory.

Step 4:

The server performs speech recognition on the buffered call audio data.

The server sends audio segments to a speech recognition resource and receives character string information that represents recognized speech.
Input: buffered call audio data with time information.
Processing: the server groups audio frames into segments, forwards the segments to a speech recognition resource, receives recognition results including recognized text and time offsets, and aligns the recognized text with the original time information.
Output: character string information and intermediate recognition results associated with time offsets.

Step 5:

The server integrates the character string information into text data.

The server consolidates partial recognition results into an ordered transcript of the call.
Input: multiple recognition results containing recognized text segments, time offsets, and confidence scores.
Processing: the server removes duplicate segments, merges overlapping segments, orders segments by time offsets, normalizes characters and punctuation, and combines them into continuous text data representing the call content.
Output: normalized text data for the call and updated structured call records including text fields.

Step 6:

The server segments and annotates the text data.

The server divides the text data into segments of a predetermined length and attaches metadata for later analysis.
Input: continuous normalized text data and associated time information.
Processing: the server splits the text data into segments based on character count, token count, or time interval, assigns segment identifiers, and adds call direction information, speaker distinction information, and call section information to each segment.
Output: a sequence of annotated text segments stored in association with the call identifier.

Step 7:

The server constructs a prompt sentence for a generative AI model.

The server composes a structured instruction string that includes criteria for determining special fraud and one or more annotated text segments.
Input: annotated text segments, system-defined criteria for determining special fraud, and an output format specification.
Processing: the server selects one or more recent segments, inserts explanatory instructions, inserts criteria such as “requests for account numbers” or “urgent transfers,” and appends the selected segments under a transcript header to form a prompt sentence.
Output: a complete prompt sentence ready to be provided to the generative AI model.

Step 8:

The server transmits the prompt sentence to the generative AI model and obtains a determination result.

The server invokes an inference interface of the generative AI model with the prompt sentence as input.
Input: the constructed prompt sentence.
Processing: the server tokenizes the prompt sentence, sends the tokens to the generative AI model, receives generated tokens as model output, converts the tokens back to text, and collects the result line or structured text that encodes a fraud label, a risk index, and a reason.
Output: a determination result including a label, a risk index, and an explanatory reason in text form.

Step 9:

The server parses and aggregates determination results.

The server converts the textual determination result into machine-readable values and integrates multiple results into a unified risk index.
Input: determination results from the generative AI model corresponding to one or more prompt sentences.
Processing: the server parses the label and numerical risk score from each result, associates each result with the corresponding text segments, and aggregates multiple scores using an aggregation method such as weighted averaging or maximum selection to calculate a final risk index for the call.
Output: an aggregated risk index and per-segment determination records linked to the call identifier.

Step 10:

The server compares the risk index with a predetermined criterion and generates warning information.

The server decides whether the call is potentially fraudulent and prepares an appropriate warning message.
Input: aggregated risk index and a stored threshold value representing the predetermined criterion.
Processing: the server evaluates whether the risk index exceeds the threshold, selects or generates a warning message template when the threshold is exceeded, and fills the template with call-specific information such as the risk index or recommended actions.
Output: warning information indicating the possibility of fraud and a decision flag indicating whether to notify the terminal.

Step 11:

The server generates and transmits notification information to the terminal.

The server prepares a notification payload that instructs the terminal to perform a warning display or warning operation.
Input: warning information, call identifier, and decision flag.
Processing: the server constructs notification information containing the warning message, call context, and risk index, selects a transmission channel (for example, push notification or signaling message), and sends the notification information through the network interface to the terminal.
Output: notification information delivered to the terminal and a log entry in the call record indicating that a warning has been issued.

Step 12:

The terminal presents the warning and records user operations.

The terminal receives the notification information and informs the user during the call.
Input: notification information received from the server.
Processing: the terminal parses the warning message and call identifier, overlays the warning message on a call user interface, optionally triggers vibration or an alert sound, and enables one-touch controls such as “End Call” or “Block Number.” The terminal monitors the user's selection or explicit dismissal of the warning.
Output: a visible or audible warning to the user and operation information representing the user's response to the warning.

Step 13:

The terminal transmits operation information to the server.

The terminal sends information about the user's call termination or rejection behavior back to the server.
Input: operation information including details such as “call ended after warning,” “call continued,” or “call rejected upon warning.”
Processing: the terminal formats the operation information with the associated call identifier and user identification information and transmits it to the server over the communication network.
Output: network messages carrying operation information delivered to the server.

Step 14:

The server stores historical records and updates prompt and threshold conditions.

The server integrates user behavior with fraud detection results to improve future system performance.
Input: operation information from the terminal, call records including text data, determination results, risk indices, and warning events.
Processing: the server writes operation information into the corresponding call record, computes performance metrics such as true positive and false positive rates, and adjusts stored parameters including conditions for constructing the prompt sentence (for example, which segments and metadata to include) and the predetermined threshold value for the risk index. The server may also update tables of phrase patterns or weights used during risk aggregation.
Output: updated call records containing complete historical information and revised configuration parameters that influence subsequent prompt sentence construction and fraud decision processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented fraud-detection and call-assistance systems suffer from several technical limitations in how they process continuous audio streams, how they integrate heterogeneous analysis components, and how they generate context-appropriate responses in real time.

First, in many existing systems, audio analysis is performed in a batch-oriented or post-hoc manner. Audio data from a communication session is buffered and processed only after the session or after long intervals, which increases end-to-end latency and prevents timely presentation of fraud warnings to a user during an ongoing communication. This architecture leads to a technical problem in that a processor and associated communication devices cannot react within a time window that is short enough to influence user behavior while the fraudulent attempt is actually occurring.

Second, conventional systems typically separate speech recognition, fraud-pattern analysis, and response generation into loosely coupled modules, often requiring manual rule configuration for each module. As a result, it is difficult to adapt response content dynamically to both the semantic content of the conversation and the emotional state of the user. The processor often treats text output from speech recognition as static data, without a unified internal representation that supports joint reasoning about fraud risk, user intent, and user emotion. This limits the precision and responsiveness of warnings and guidance produced by the computer system.

Third, in many implementations, emotion analysis (if present at all) is used merely for reporting or logging, not as a real-time control signal that influences how the system generates prompts to an artificial intelligence model and how it selects warning strategies. Consequently, the processor cannot optimize its use of computational resources and model capabilities to match the detected emotional state of the user, for example by intensifying warnings for highly distressed users or initiating emergency notifications when a risk threshold is exceeded.

Fourth, traditional response-generation mechanisms rely on fixed, preauthored templates or simple branching logic. Such mechanisms lack the flexibility to accommodate diverse fraud scenarios and service-operation requests, and they do not leverage modern generative AI models in a way that is systematically integrated into the overall processing pipeline. The absence of a structured “prompt sentence” mechanism tied to upstream analysis results limits the system's ability to generate technically coherent, context-sensitive, and emotionally appropriate responses at runtime.

Furthermore, many systems do not provide an integrated mechanism by which a user device can dynamically switch between ordinary call handling and fully automated handling by an artificial intelligence engine, while maintaining low-latency media routing over the communication path. Without such a mechanism, it is technically difficult for a processor to perform seamless AI takeover of an ongoing call and to generate synthesized audio that is transmitted to a counterpart terminal with minimal disruption.

Accordingly, there is a need for improvements in computer technology, specifically in the design and operation of processors that (i) perform streaming speech-to-text conversion, (ii) analyze text for fraud-related patterns and user emotional states, (iii) synthesize structured prompt sentences for generative AI models based on these analyses, (iv) generate real-time warning, guidance, and emergency notifications, and (v) coordinate automatic call handling through a communication path. The technical challenge is to provide an integrated system architecture and processing method that reduce latency, increase the accuracy and context-sensitivity of responses, and improve the robustness and safety of user interactions in communication environments susceptible to fraudulent activity.

The specific processing by the specific processing unit 290 of the data processing device 12 in Application Example 2 is realized by the following means.

The present invention provides a server comprising a processor configured to acquire acoustic information during a communication session and convert the acoustic information into character information in a streaming manner, analyze the character information to determine whether the character information includes an expression pattern related to fraudulent activity, generate a prompt sentence to be input to a generative information processing model on the basis of the character information and a result of the determination, request the generative information processing model to generate a response by using the prompt sentence and obtain a response character string from the generative information processing model, generate warning information or guidance information on the basis of the response character string and transmit the warning information or the guidance information to a user device in real time, analyze an emotional state of a user on the basis of at least one of the character information and the acoustic information and adjust at least one of the prompt sentence and contents of the warning information or the guidance information in accordance with the emotional state, and, when the emotional state exceeds a predetermined threshold, generate emergency notification information and transmit the emergency notification information to a preset emergency contact via a communication path. This enables the computer system to implement an integrated, low-latency processing pipeline in which streaming audio is continuously converted and analyzed, fraud risk and user emotion are jointly evaluated by the processor, prompt sentences are automatically synthesized and supplied to a generative AI model, and context-appropriate warnings, operational guidance, and emergency notifications are generated and delivered in real time, thereby improving the technical performance, responsiveness, and safety of computer-implemented communication and fraud-mitigation systems.

The term “system” refers to an arrangement of one or more computing devices and one or more user devices configured to execute the processing operations described in the claims.

The term “processor” refers to one or more hardware processing units, such as a central processing unit, a graphics processing unit, or a dedicated logic circuit, configured to execute instructions that implement the claimed functions.

The term “acoustic information” refers to information representing sound, including, for example, voice signals, stored or transmitted as digital audio data.

The term “character information” refers to textual data obtained by converting acoustic information into a sequence of characters or symbols using a speech recognition process.

The term “expression pattern related to fraudulent activity” refers to a linguistic pattern, term, phrase, or combination of phrases that is indicative of, or statistically associated with, a fraudulent act or an attempt to deceive a user.

The term “prompt sentence” refers to a textual instruction or input sequence that is provided to a generative information processing model to cause the model to generate a response in accordance with a desired task or role.

The term “generative information processing model” refers to a trained computational model, such as a machine learning model or artificial intelligence model, configured to generate new text or other information based on an input, including a prompt sentence.

The term “response character string” refers to textual output generated by the generative information processing model in response to a prompt sentence.

The term “warning information” refers to information, including textual information or audio information, that notifies a user about a risk, such as a risk of fraudulent activity.

The term “guidance information” refers to information, including textual information or audio information, that provides instructions, steps, or advice to a user regarding an operation, procedure, or response.

The term “user device” refers to any terminal apparatus operated by a user, such as a communication terminal, a mobile terminal, a smartphone, or another computing device capable of interacting with the system.

The term “communication session” refers to a period of communication between at least two endpoints, including, for example, a voice call, a voice-over-network session, or another interactive audio exchange.

The term “emotional state” refers to a psychological state of a user, such as fear, anger, anxiety, or calmness, inferred from at least one of acoustic information, character information, or other sensor data.

The term “predetermined threshold” refers to a value or condition defined in advance, such as a numerical threshold or logical criterion, used by the processor to decide whether the emotional state warrants an emergency response.

The term “emergency notification information” refers to information, including textual information or audio information, that indicates a potential emergency condition related to a user and is intended to alert an emergency contact.

The term “emergency contact” refers to an entity, such as a person, an organization, or a service, registered in the system to receive emergency notification information when certain conditions are satisfied.

The term “template” refers to a predefined text pattern or structure including one or more placeholder fields into which character information, analysis results, or other data are inserted to form a prompt sentence.

The term “fraud risk evaluation template” refers to a template configured to generate a prompt sentence that causes the generative information processing model to evaluate a level of fraud risk.

The term “user alert template” refers to a template configured to generate a prompt sentence that causes the generative information processing model to create a message for alerting a user to a risk.

The term “user procedure guidance template” refers to a template configured to generate a prompt sentence that causes the generative information processing model to create stepwise instructions for a user operation or procedure.

The term “emergency notification template” refers to a template configured to generate a prompt sentence that causes the generative information processing model to create a message suitable for notifying an emergency contact.

The term “analysis result of the emotional state” refers to data obtained by processing acoustic information, character information, or other inputs to infer and quantify the user's emotional state.

The term “determination result of the expression pattern related to the fraudulent activity” refers to data indicating whether and to what extent the character information includes an expression pattern related to fraudulent activity.

The term “operation information” refers to input data generated by interaction with a user device, such as a button press, a touch operation, or another user action that indicates a mode or function selection.

The term “normal call handling” refers to a mode in which a communication session is conducted without automatic generation of conversational content by a generative information processing model.

The term “automatic handling” refers to a mode in which at least part of the conversational content in a communication session is generated automatically by the generative information processing model and provided to a counterpart.

The term “communication path” refers to a logical or physical path, including a network connection, over which audio or other data is transmitted between the system and a counterpart terminal.

The term “counterpart terminal” refers to a communication endpoint other than the user device, such as another telephone terminal, communication terminal, or computing device participating in the communication session.

In one embodiment, a server, a terminal, and a user cooperate to implement the claimed system.

The following description illustrates exemplary hardware and software configurations and data-processing operations that enable a skilled person to implement the invention.

Server includes at least one hardware processor, a main memory, a non-volatile storage device, a network interface, and optionally a dedicated signal processing unit.

Server executes an operating system and multiple application programs including a speech recognition client module, a text analysis module, a fraud-pattern analysis module, an emotion-analysis module, a prompt-generation module, a generative AI interface module, a decision engine, a text-to-speech client module, and a communication controller.

Terminal includes at least one hardware processor, a memory, a wireless communication interface, a microphone, a speaker, a display, and optionally an imaging sensor and a vibration motor.

Terminal executes an operating system and a communication application configured to capture voice from User, send the captured audio and associated metadata to Server, present warnings or guidance from Server, and optionally switch between normal call handling and automatic handling by the system.

User operates Terminal during a communication session.

User may place an outgoing call, receive an incoming call, or launch an application that provides voice-based guidance for communication-service operations or electronic transaction operations.

User may manually activate an AI-assist mode via a dedicated button or soft key, and may approve the use of additional sensors such as the imaging sensor.

Server acquires acoustic information from Terminal through the network interface.

Server receives audio frames containing sampled voice signals encoded using a compression format such as a wideband voice codec.

Server stores the audio frames in an input buffer in memory and maintains session-level metadata in a structured data record including session identifier, timestamps, direction indicator, language code, and current processing state.

Server converts acoustic information into character information using a speech recognition program.

Server may call an external speech recognition service or execute a local recognizer configured as a deep neural network acoustic model combined with a language model.

Server may use, by way of example, a hybrid model in which a recurrent or transformer-based acoustic model maps sequences of acoustic feature vectors (such as Mel-frequency cepstral coefficients or filter-bank energies) to phoneme or subword probabilities, and a statistical or neural language model decodes the most probable word sequence.

Server outputs the recognized word sequence as character information in a specified character encoding and stores the sequence in a text buffer associated with the session record.

Server analyzes character information to determine whether character information includes an expression pattern related to fraudulent activity.

Server applies a text preprocessing pipeline that tokenizes the character information, normalizes lexical variants, removes stop words, and maps tokens to vector representations using a word-embedding model or a contextual embedding model.

Server stores the resulting token sequence and embedding vectors in a structured data object.

Server then compares this data object with a stored fraud-pattern repository maintained in storage.

Server may store each fraud pattern as a combination of lexical features, syntactic patterns, and semantic embedding vectors derived from training data representing known fraudulent scenarios.

Server computes similarity scores between the current character information and each stored pattern, for example using cosine similarity or a learned scoring function implemented as a shallow neural network or gradient-boosted decision tree.

Server determines a fraud-risk score by aggregating the similarity scores and normalizing them to a numeric range.

Server records the fraud-risk score and the associated pattern identifiers in the session record.

Server analyzes an emotional state of User based on at least one of character information and acoustic information.

Server may extract prosodic features from the acoustic information, including pitch, energy, speaking rate, and spectral tilt, by using a digital signal processing library.

Server may also derive sentiment and emotion features from the character information, such as polarity scores, subjectivity scores, and predicted emotion labels.

Server combines these features into a feature vector and inputs the feature vector to an emotion classifier.

Server may implement the emotion classifier as a neural network that includes, for example, an input layer for acoustic and textual features, one or more hidden layers configured as fully connected layers, recurrent layers, or self-attention layers, and an output layer producing probability values for emotion categories such as fear, anger, sadness, and calm.

Server obtains an emotional-state vector and stores it in the session record.

Server also derives an emotional-state score (for example, a fear intensity value) and compares this score to a predetermined threshold.

Server generates a prompt sentence for a generative AI model based on the character information and the fraud-risk score and, in certain embodiments, also based on the emotional-state vector.

Server maintains in storage a set of templates for prompt sentences, each template corresponding to a particular task type, such as fraud risk evaluation, user alert, user procedure guidance, or emergency notification.

Server selects a template by applying a rule engine that takes as input the fraud-risk score, the emotional-state score, and any detected user intent (for example, an intent to change a communication plan or change a payment method).

Server may classify the task type by using a deterministic rule set (for example, thresholding the fraud-risk score) or by using a machine-learned classifier.

Server then populates the selected template with character information and analysis results.

Server may generate, for example, the following prompt sentences as plain text:
“You are a fraud-detection assistant. Analyze the following call transcript and determine whether it contains patterns of special fraud. Respond with a risk level (low, medium, high) and a short explanation. Transcript: [call transcript]”

“The user wants to change their communication plan. Using simple and polite language, provide step-by-step instructions to change the plan in a mobile communication application.

User request: [recognized user utterance]”

“The user wants to change the payment method for an online transaction service. Generate clear, step-by-step voice guidance to update the payment settings. User request: [recognized user utterance]”

“The user sounds very anxious and confused. Generate a short, calm, and reassuring message that warns about possible fraud and explains the next safe steps.”

“The user may be in danger. Based on the following emotional-state data and location information, compose a concise, clear emergency alert message for the user's trusted contact.

Data: [emotional-state values and location].”

Server assembles each prompt sentence into a request payload for a generative AI model.

Server may configure the generative AI model as a transformer-based neural network trained on sequence-to-sequence language modeling tasks.

Server may use a model architecture that includes a multi-layer attention mechanism, positional encodings, feed-forward sublayers, and layer-normalization.

Server maintains or accesses model parameters, including weight matrices for attention, projection layers for token embeddings, and bias vectors.

Server may run the model locally or invoke a remote inference service via an application programming interface.

Server provides the prompt sentence and, optionally, additional context inputs such as system instructions, conversation history, or structured analysis results, to the generative AI model.

Server configures generation parameters such as maximum token length, temperature, and top-k or nucleus sampling thresholds, which influence the diversity and determinism of the generated text.

Server causes the generative AI model to compute attention weights over the token sequence, propagate activations through successive transformer layers, and compute a probability distribution over output tokens at each generation step.

Server samples or selects tokens according to the configured parameters and continues generation until a termination condition is met.

Server obtains a response character string that typically includes a fraud-risk assessment, an explanatory message, user-facing guidance, or a text segment suitable for emergency notification.

Server adjusts the content of the prompt sentence and the expected structure of the response in a manner that is different from simple rule-based automation.

Server uses continuous-valued features such as fraud-risk score and emotional-state score as control signals that influence both template selection and internal instructions within the prompt sentence.

Server may insert explicit control tokens or meta-instructions into the prompt sentence, such as “Use a calm and reassuring tone because the user's fear level is high,” or “Focus on safety steps and avoid requesting any sensitive information,” which alter the generative path within the model.

This technical configuration enables the generative AI model to operate under dynamic constraints derived from real-time analysis, rather than merely automating fixed human scripts.

Server generates warning information or guidance information based on the response character string.

Server may parse the response character string to separate segments corresponding to fraud assessment, user-facing warning, operational instructions, and emergency actions.

Server may use structural cues such as marker phrases or delimiters introduced in the prompt sentence.

Server constructs one or more message objects that include text content, priority indicators, and target audiences (for example, user, counterpart terminal, or emergency contact).

Server stores these message objects and forwards them to appropriate output modules.

Server converts text content for user-facing messages into audio using a text-to-speech engine.

Server may call a waveform synthesis engine that implements a neural vocoder such as a convolutional or autoregressive model, conditioned on phoneme sequences and prosodic features.

Server may specify prosody parameters derived from the emotional-state vector, for example selecting a slower speaking rate and softer intonation when a high fear level is detected to improve user comprehension and comfort.

Server produces digital audio data representing the synthesized message and returns this data to Terminal over a communication channel.

Terminal receives the warning information or guidance information from Server.

Terminal decodes the audio data and plays the audio through the speaker or earpiece.

Terminal displays the text content on the display as a pop-up dialog, notification banner, or in-application message.

Terminal may apply visual emphasis, such as color changes or icons, when Server designates a message as urgent.

Terminal may also trigger the vibration motor when a fraud-risk score or emotional-state score exceeds a specified threshold, thereby providing a multimodal alert that can be perceived even when sound is not heard clearly.

User perceives the audio and visual alerts and may decide to terminate the call, proceed with caution, or follow the operational guidance.

User may also manually initiate an AI-assist mode.

When AI-assist mode is active, Terminal routes ongoing call media to Server, mutes User's voice toward the counterpart terminal, and allows Server to provide synthesized responses to the counterpart.

This configuration enables a technical capability in which call control rerouting and AI-generated media transmission are performed at low latency, without requiring manual script reading or manual decision making.

Server, when an emotional-state score exceeds a predetermined threshold, generates emergency notification information and transmits the emergency notification information to an emergency contact.

Server may obtain location information and other context data from Terminal and incorporate this data into the emergency notification information.

Server may again use a prompt sentence to generate clear and concise emergency text that is easy for a recipient system or human recipient to understand.

Server may send the notification through a messaging gateway, an email system, or another external service interface controlled by the server computer.

This technical design ensures that emergency flows reuse the same prompt-generation and generative modeling architecture, maintaining consistency and reducing implementation complexity.

Server improves computer-implemented processing compared to conventional systems in several ways.

Server reduces end-to-end latency for fraud detection and guidance by operating on streaming acoustic information with incremental speech recognition and immediate fraud-pattern scoring; this contrasts with batch-oriented analysis that would only operate after the communication session.

Server improves accuracy of fraud detection and emotional estimation by combining multiple feature types (acoustic features, lexical features, embedding-based semantic features) and by using machine-learned models trained on large corpora of fraudulent and non-fraudulent communications, which enable recognition of paraphrased or obfuscated fraud patterns that simple string matching would miss.

Server improves computational efficiency by using structured session records and feature caches, which avoid repeated computation of embeddings and scores for identical or overlapping text segments.

Server uses specific training procedures to configure the fraud-pattern analysis model and the emotion-analysis model.

Server may train a fraud classification model by minimizing a cross-entropy loss between predicted fraud probabilities and ground-truth labels obtained from annotated communication logs.

Server may update model weights using stochastic gradient descent or a variant such as Adam optimization, with mini-batch training on shuffled data.

Server may apply data augmentation techniques, such as paraphrasing, synonym substitution, or noise injection into textual data, to improve robustness to variations in attacker phrasing.

Server may train the emotion classifier with supervised labels representing different emotional states; Server may tune hyperparameters such as learning rate, number of layers, hidden dimension size, and regularization factors based on validation metrics.

Server designs data structures and processing pipelines in a way that is specialized for the real-time fraud-detection and guidance task.

Server uses separate memory regions for raw acoustic buffers, transcribed text buffers, feature vectors, model outputs, prompt sentences, and response messages.

Server tags each piece of data with a session identifier and timestamp, enabling strict ordering and synchronization among modules.

Server employs asynchronous message queues between modules so that speech recognition, fraud pattern scoring, emotion analysis, generative response generation, and text-to-speech conversion can proceed concurrently on overlapping time segments.

This concurrency model reduces average latency and uses processor and network resources more efficiently than a strictly sequential pipeline.

Server, by generating prompt sentences that embed not only user text but also numerical analysis results, enables the generative AI model to follow a processing regime that differs from human operators.

Server instructs the model through explicit meta-instructions and dynamically varied templates that depend on internal scores, resulting in responses that adapt to measurable signal-level and semantic-level conditions.

This architecture is not merely automating a human decision tree but is instead structuring the internal computation of the generative AI model using system-generated control variables, thereby improving repeatability and consistency of decisions, and reducing reliance on manual scripting.

In alternative embodiments, Server may employ different underlying models for individual modules while preserving the claimed architecture.

Server may use a convolutional neural network-based acoustic model or a transformer-only model for speech recognition.

Server may use a rule-enhanced fraud-pattern detector in which patterns extracted via machine learning are combined with manually defined patterns stored in an efficient search index.

Server may implement the emotion-analysis module using a joint audio-text model, or a model that additionally incorporates sensor data, such as motion sensors or ambient noise levels.

Server may vary the architecture of the generative AI model, such as encoder-decoder models, decoder-only models, or mixtures of experts, provided that the model accepts prompt sentences and produces response character strings.

Terminal may also vary in form factor, including mobile devices, fixed communication terminals, or embedded communication systems in vehicles or appliances.

Terminal may incorporate specialized hardware for low-latency audio capture and playback, such as dedicated audio digital signal processors.

Terminal may integrate directly with a communication carrier's infrastructure or may operate over packet-based networks, with corresponding adaptations to the communication controller in Server.

Through these configurations, Server, Terminal, and User cooperatively implement a concrete technical system that improves the way computer technology performs speech-to-text conversion, fraud-pattern detection, emotion-state inference, prompt generation, generative response computation, and media routing.

The system achieves increased detection accuracy, reduced latency, improved utilization of computational resources, and enhanced safety for users in communication environments that are vulnerable to fraudulent activity.

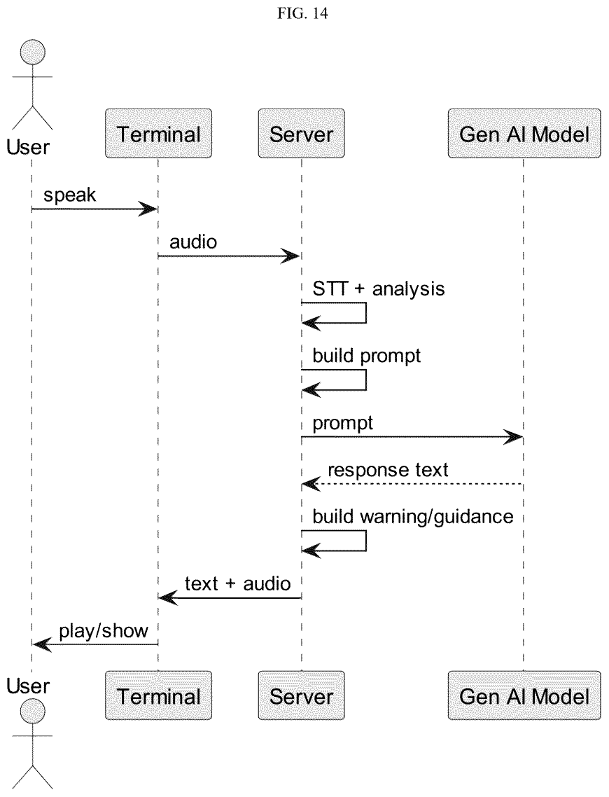

The following describes the processing flow using FIG. 14.

Step 1:

User initiates a communication.

User starts a voice interaction by placing or receiving a call, or by launching an application and speaking a request such as “I want to change my communication plan” or “Someone says my bank account was misused.”
Input: Human speech (analog voice).
Output: Acoustic vibrations captured by Terminal.

Terminal activates a microphone, converts the analog voice into digital samples (for example, 16-bit PCM at 16 kHz), and prepares audio frames for transmission.

Step 2:

Terminal transmits audio to Server.

Terminal segments the digital samples into audio frames (for example, 20-40 ms per frame), encodes the frames using an audio codec, and sends them over a secure channel to Server.
Input: Digital audio samples from the microphone.
Output: Encoded audio packets transmitted over the network.

Terminal attaches metadata such as session identifier, direction flag (user side or counterpart side), and timestamp to each packet before sending.

Step 3:

Server buffers and organizes incoming audio.

Server receives encoded audio packets and reconstructs an ordered audio stream for each session by sorting packets and reassembling frames.

Input: Encoded audio packets from Terminal.

Output: Session-specific audio buffers stored in memory.

Server decodes each packet into PCM samples and stores contiguous segments (for example, several hundred milliseconds to a few seconds) in a circular buffer associated with a session record.

Step 4:

Server converts audio to text (speech recognition).

Server calls a speech recognition module to transform buffered PCM audio into character information.

Input: Buffered PCM audio segments.

Output: Transcribed character strings with timestamps and confidence scores.

Server extracts acoustic features (such as Mel-frequency cepstral coefficients or filter-bank energies) and feeds sequences of features into a neural acoustic model.

Server applies a decoding algorithm with a language model to output the most probable sequence of words or subword units, and then stores this text in a session text buffer.

Step 5:

Server preprocesses the text for analysis.

Server normalizes the transcribed text to a canonical form suitable for pattern detection.

Input: Raw transcribed character strings.

Output: Tokenized and normalized text representation.

Server performs operations such as lowercasing, punctuation stripping, tokenization into words or subwords, and optional lemmatization.

Server maps tokens to numeric vectors using an embedding table and stores both tokens and vectors as a structured data object.

Step 6:

Server evaluates fraud patterns in the text.

Server compares the current text segment to a repository of expression patterns related to fraudulent activity.

Input: Tokenized text and token embeddings.

Output: Fraud-risk score and, optionally, matched pattern identifiers.

Server computes similarity scores between the current text embeddings and stored pattern embeddings using vector operations such as dot products and cosine similarity.

Server aggregates similarity values (for example, by a weighted sum or a learned scoring layer) to produce a numeric fraud-risk score, then updates the session record with this score.

Step 7:

Server analyzes the user's emotional state.

Server estimates User's emotional state based on acoustic and textual signals.

Input: Acoustic features (for example, pitch, energy) and preprocessed text features (for example, sentiment indicators).

Output: Emotional-state vector and derived scalar scores (for example, fear level).

Server calculates prosodic descriptors over sliding windows and constructs a combined feature vector.

Server feeds this feature vector into an emotion classifier network, which outputs probabilities for emotions such as fear, anger, sadness, and calmness.

Server records the full emotional-state vector and derives a scalar emotion intensity value for use in later decisions.

Step 8:

Server determines the processing context.

Server decides whether the current situation is primarily fraud checking, service guidance, emergency handling, or some combination.

Input: Fraud-risk score, emotional-state vector, and optionally user intent (if already detected).

Output: Context label (for example, “fraud_high”, “guidance_change_plan”, “emergency_possible”).

Server applies threshold-based rules (for example, fraud-risk score above a high threshold) and, if available, an intent classifier to assign the context label, which is stored in the session record.

Step 9:

Server constructs an appropriate prompt sentence.

Server generates a prompt sentence to guide a generative AI model based on analysis results.

Input: Context label, text transcript, fraud-risk score, and emotional-state data.

Output: A task-specific prompt sentence as text.

Server selects a prompt template from a template set (for example, fraud evaluation, user alert, service operation guidance, emergency notification) and substitutes variables such as “[call transcript]” and “[fear level]” with actual values.

Server may, for example, generate one of the following prompt sentences:

“You are a fraud-detection assistant. Analyze the following call transcript and determine whether it contains patterns of special fraud. Respond with a risk level (low, medium, high) and a short explanation. Transcript: [call transcript]”

“The user wants to change their communication plan. Using simple and polite language, provide step-by-step instructions to change the plan in a mobile communication application.

User request: [recognized user utterance]”

“The user wants to change the payment method for an online transaction service. Generate clear, step-by-step voice guidance to update the payment settings. User request: [recognized user utterance]”

“The user sounds very anxious and confused. Generate a short, calm, and reassuring message that warns about possible fraud and explains the next safe steps.”

“The user may be in danger. Based on the following emotional-state data and location information, compose a concise, clear emergency alert message for the user's trusted contact.

Data: [emotional-state values and location].”

Step 10:

Server requests a response from a generative AI model.

Server sends the constructed prompt sentence to a generative AI model to obtain a response character string.

Input: Prompt sentence and optional context (for example, short history of previous system messages).

Output: Response character string generated by the model.

Server calls a generative AI interface module that packages the prompt sentence, sets generation parameters (for example, maximum tokens, temperature), and invokes the model via an application programming interface.

Server receives token outputs from the model, concatenates them into a text sequence, and passes this sequence to the decision engine.

Step 11:

Server parses and categorizes the model's response.

Server interprets the response character string to identify elements such as fraud assessment, user warning, guidance steps, and emergency actions.

Input: Response character string from the generative AI model.

Output: Structured response object with labeled segments.

Server scans the text for marker phrases or formats expected from the chosen template and splits the text into sections (for example, “Risk: high”, “Message to user: . . . ”, “Actions: . . . ”).

Server represents each section as a field within a response object stored in the session record.

Step 12:

Server decides what to present and whom to notify.

Server uses the structured response, fraud-risk score, and emotional-state score to determine final actions.

Input: Structured response object, fraud-risk score, emotional-state score, and context label.

Output: Action flags and output message definitions (for example, warning to user, guidance, emergency notification).

Server applies a rule set that may include conditions such as “if fraud-risk score is high and fear level is moderate, show strong warning and suggest ending the call,” or “if fear level exceeds a threshold, also prepare an emergency notification.”

Server sets flags indicating which messages will be sent to User, to the counterpart terminal, or to an emergency contact.

Step 13:

Server generates user-facing warning and guidance messages.

Server formulates text messages for display and, if needed, for speech synthesis, based on the response character string and action flags.

Input: Structured response object and action flags.

Output: Final text messages for User and, optionally, for the counterpart terminal.

Server formats the text to be concise and suitable for the terminal display, and may adjust wording to match the emotional-state information (for example, using a calmer tone when high fear is detected).

Server creates separate message objects for screen display and TTS conversion.

Step 14:

Server synthesizes audio from text messages.

Server converts selected text messages into digital audio suitable for playback.

Input: Text messages designated for audio output.

Output: Synthesized audio data (for example, PCM or compressed audio files).

Server passes each message to a text-to-speech engine, sets parameters such as voice type, speaking rate, and intonation, and receives generated audio frames.

Server stores the audio data and associates it with intended playback targets (for example, User's terminal, counterpart terminal).

Step 15:

Server transmits messages and audio to Terminal.

Server sends prepared messages and synthesized audio to Terminal using a predefined communication protocol.

Input: Audio data and text messages, plus priority and presentation metadata.

Output: Network packets containing output payloads delivered to Terminal.

Server includes flags indicating whether the message is a fraud warning, guidance, or emergency status, and attaches control parameters such as “vibrate =true” or “show as pop-up=true.”

Step 16:

Terminal presents warnings and guidance to User.

Terminal receives the messages, decodes the audio data, and controls local hardware to notify User.

Input: Audio data and text messages from Server.

Output: Audible guidance and on-screen alerts perceivable by User.

Terminal plays audio through the speaker or earpiece, displays text on the screen, and, if requested, activates vibration or visual highlighting.

Terminal may show options such as “End call,” “Hold call,” or “More info,” depending on the message type.

Step 17:

User reacts to the system output.

User listens to the warnings or instructions and decides how to proceed.

Input: Audible and visual information from Terminal.

Output: User actions, such as ending the call, continuing the call, or following guidance steps.

User may select on-screen options or press a hardware button that Terminal interprets as user feedback to send back to Server.

Step 18:

Terminal sends user feedback and mode changes to Server.

Terminal reports key user actions and mode selections.

Input: User interactions (for example, button presses, mode selection, AI-assist activation).

Output: Feedback messages and control signals sent to Server.

Terminal updates a local state (for example, switching from normal handling to automatic handling) and informs Server of the new state so that Server can adjust processing accordingly.

Step 19:

Server optionally takes over call responses in automatic mode.

Server, when automatic handling is active, continues to receive call audio, generate model-based responses, and send synthesized replies to be played toward the counterpart.

Input: Ongoing audio from both sides of the call, plus current mode state from Terminal.

Output: AI-generated audio responses transmitted to the counterpart via Terminal.

Server uses the same speech-to-text, text analysis, prompt sentence generation, and generative AI model pipeline to generate responses directed at the counterpart terminal, rather than only at User, and coordinates timing to maintain conversational flow.

Step 20:

Server triggers emergency notifications when thresholds are exceeded.

Server, upon detecting that the emotional-state score exceeds a predetermined threshold, prepares and sends an emergency notification.

Input: Emotional-state vector, threshold values, contextual data (for example, location from Terminal), and possibly a specialized prompt sentence.

Output: Emergency notification message delivered to an emergency contact system.

Server may generate an emergency-specific text using a prompt sentence such as “Based on these fear and location data, draft a clear alert for the user's trusted contact,” obtain text from the generative AI model, and send the text via external messaging channels.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

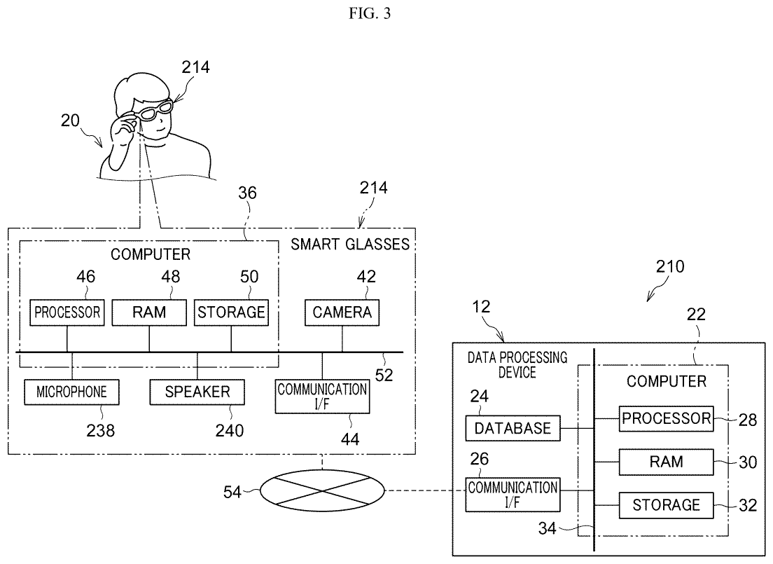

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

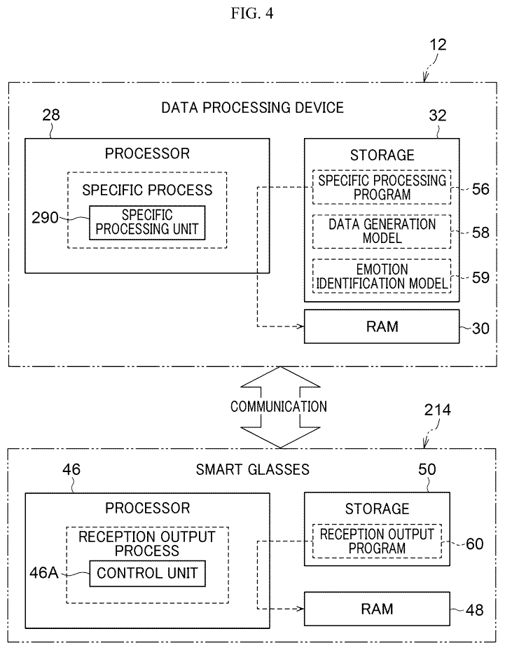

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

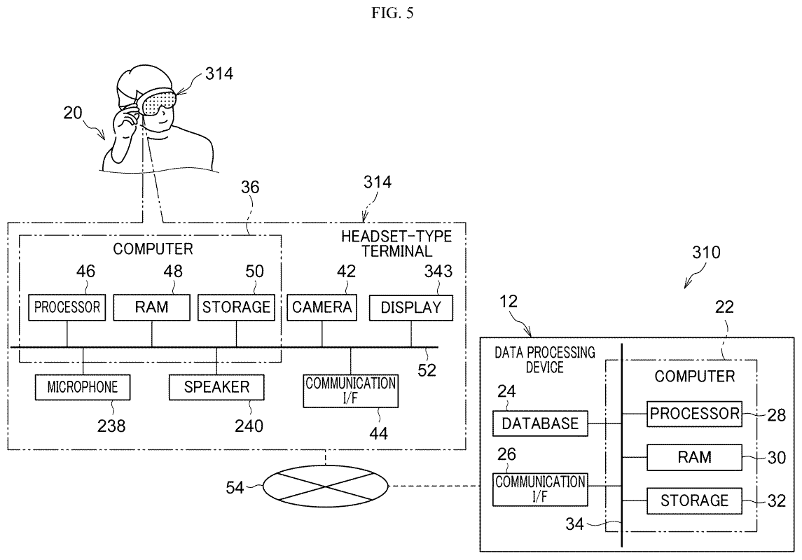

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

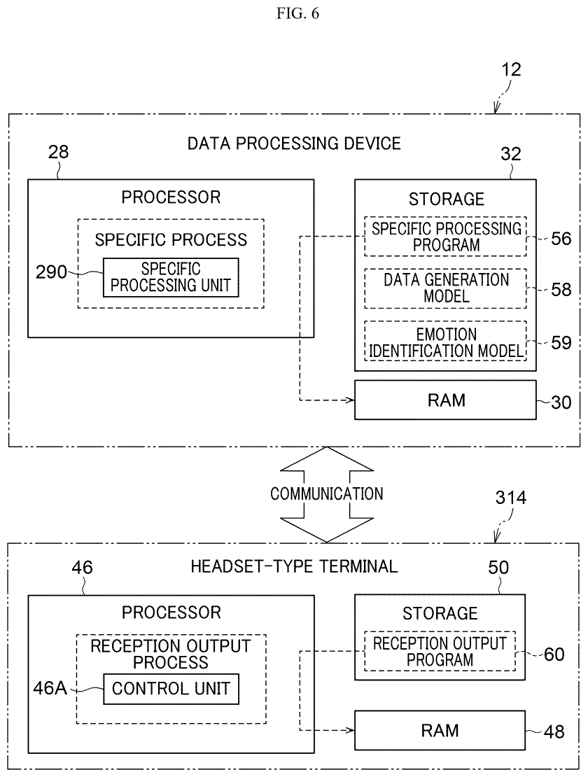

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

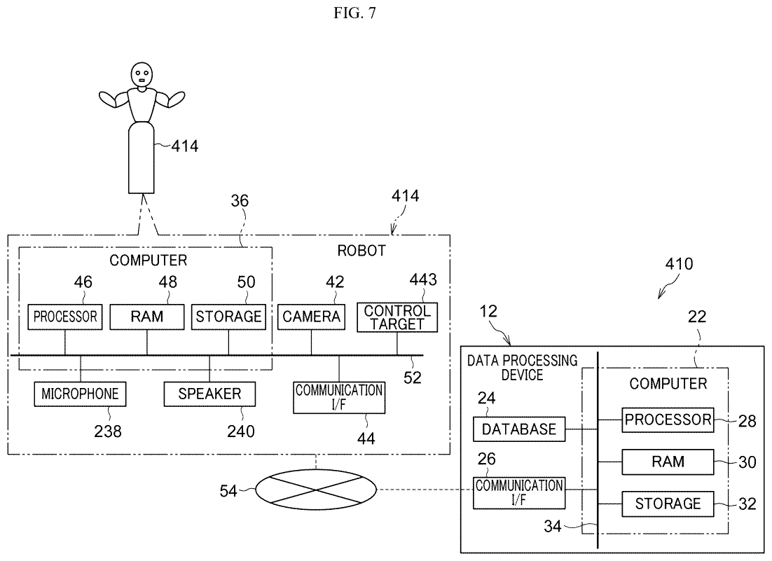

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

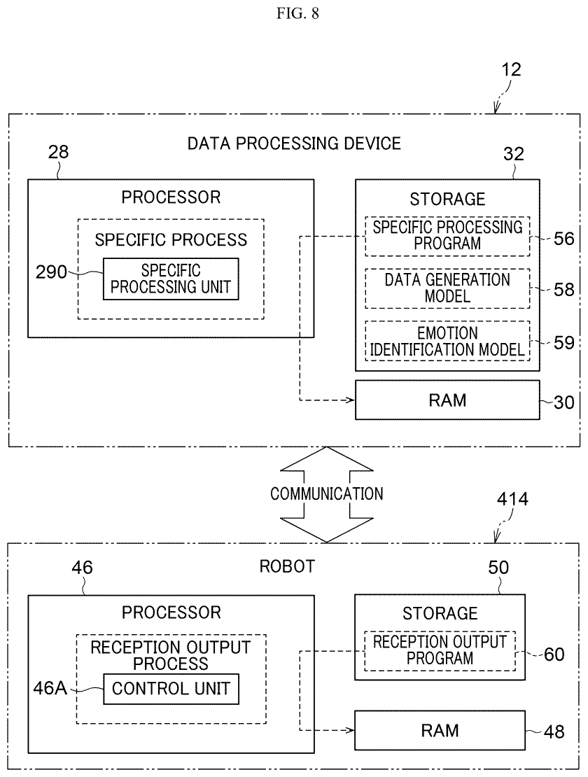

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

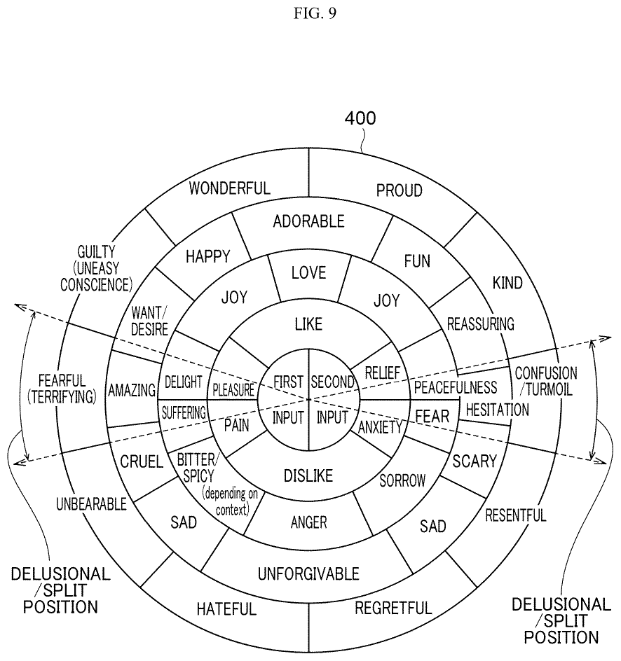

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

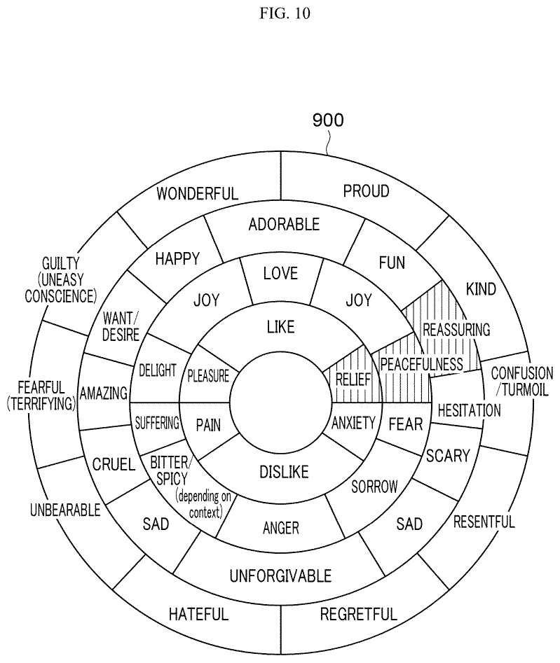

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire voice data,
convert the voice data into text data,
analyze the text data to determine a possibility of fraud,
generate a prompt sentence including conditions for response generation to a fraud scene,
based on an analysis result and the text data,
input the prompt sentence to a generative AI model to cause the generative AI model to generate a response as text,
convert the generated text into voice data,
transmit the voice data via a communication path to a counterpart terminal to output the voice data as an automatic response during a call, and
in response to a single operation instruction from a user terminal, switch a call response mode from a user response to the automatic response.

### Supplementary 2

The system according to supplementary 1,
wherein the processor is configured to
apply, to the text data, a determination model learned by a machine learning scheme using typical expression patterns of fraud and fraud risk indices, calculate presence or absence of the possibility of fraud and a fraud risk level based on an output of the determination model, and dynamically change a response policy and a response style included in the prompt sentence according to the fraud risk level.

### Supplementary 3

The system according to supplementary 1,
wherein the processor is configured to
when the possibility of fraud is determined to exceed a predetermined criterion, generate notification information including at least the fraud risk level, a part of the text data, and a summary of response content generated by the generative AI model, transmit the notification information to the user terminal, and cause the user terminal to display the notification information.

### Application Example 1

### Supplementary 1

A system comprising a processor,
wherein the processor is configured to
acquire audio information and convert the audio information into text information, and
analyze the text information to generate evaluation information for detecting patterns indicating a possibility of fraudulent activity in communication content, and
generate a prompt sentence to be input to a generative information processing model based on the evaluation information and the text information, and
cause the generative information processing model, by using the prompt sentence, to execute determination processing regarding a possibility of fraudulent activity and calculate risk information relating to the fraudulent activity from a determination result, and
generate notification information including the risk information and warning information based on the determination result when the risk information satisfies a predetermined criterion, and transmit the notification information to a user information processing terminal, and
continuously acquire audio information during an ongoing communication from the user information processing terminal and update the text information, the evaluation information, and the risk information in a time-series manner to continuously monitor a possibility of fraudulent activity over an entire duration of the communication, and
cause the user information processing terminal, in response to the notification information, to provide operation information for receiving a user operation regarding continuation or termination of the communication, and
generate a response prompt sentence for automatically responding in place of a user in a dialogue with a communication partner in response to an instruction from the user information processing terminal, and cause an audio response based on a response sentence generated by the generative information processing model using the response prompt sentence to be transmitted to the communication partner.

### Supplementary 2

The system according to supplementary 1,
wherein the processor is configured to execute machine learning processing for learning typical linguistic expression patterns of fraudulent activity in generating the evaluation information, and to perform control to correct the risk information based on a learning result.

### Supplementary 3

The system according to supplementary 1,
wherein the processor is configured to cause the user information processing terminal to present, in the notification information, a simple explanation based on the determination result by the generative information processing model and a recommended countermeasure for the user in addition to presence or absence of the possibility of fraudulent activity.

### Example 2

### Supplementary 1

A system comprising a processor,
wherein the processor is configured to
acquire call audio data as voice input from a communication apparatus, and associate the call audio data with communication information including time information and user identification information and store the associated data, and
transmit the call audio data to an information processing resource that performs speech recognition processing, and receive character string information generated by the speech recognition processing, and integrate the character string information based on the time information to generate text data, and
construct a prompt sentence for inputting the text data into a generative AI model having natural language processing functionality, the prompt sentence including at least criteria for determining special fraud, an output format, and at least a part of the text data, and cause the generative AI model to output a determination result regarding a possibility of fraud, and
analyze the determination result obtained from the generative AI model, determine whether a risk index corresponding to the possibility of fraud satisfies a predetermined criterion, and
store the determination result and the risk index as call records, and
when it is determined that the risk index satisfies the predetermined criterion, generate and transmit notification information including warning information to the communication apparatus so as to cause the communication apparatus to execute a warning display or a warning operation indicating the possibility of fraud related to the call.

### Supplementary 2

The system according to supplementary 1,
wherein the processor is configured to
divide the text data generated in accordance with progress of the call into segments of a predetermined length when constructing the prompt sentence, add call direction information, speaker distinction information, and call section information to the divided text data, input the divided text data sequentially into the generative AI model, and integrate a plurality of determination results received from the generative AI model to calculate the risk index.

### Supplementary 3

The system according to supplementary 1,
wherein the processor is configured to
store, in association with each other, the determination result obtained from the generative AI model, the risk index, the warning information, and operation information regarding a call termination operation or a rejection operation performed by a user, and update at least one of conditions for constructing the prompt sentence and the predetermined criterion based on stored information.

### Application Example 2

### Supplementary 1

A system comprising a processor,
wherein the processor is configured to
acquire acoustic information and convert the acoustic information into character information,
analyze the character information to determine whether the character information includes an expression pattern related to fraudulent activity,
generate a prompt sentence to be input to a generative information processing model on the basis of the character information and a result of the determination,
request the generative information processing model to generate a response by using the prompt sentence and obtain a response character string from the generative information processing model,
generate warning information or guidance information on the basis of the response character string and transmit the warning information or the guidance information to a user device,
sequentially acquire the acoustic information during a communication session, store the acoustic information as the character information, and sequentially execute the determination of the expression pattern related to the fraudulent activity and the generation of the prompt sentence during the communication session so as to present, in real time, the warning information or the guidance information to the user device,
analyze an emotional state of a user on the basis of at least one of the character information and the acoustic information and adjust at least one of the prompt sentence used for the generative information processing model and contents of the warning information or the guidance information in accordance with the emotional state, and
when the emotional state exceeds a predetermined threshold, generate emergency notification information and transmit the emergency notification information to a preset emergency contact.

### Supplementary 2

The system according to supplementary 1,
wherein the processor is configured to
generate the prompt sentence for the generative information processing model, on the basis of an analysis result of the emotional state and a determination result of the expression pattern related to the fraudulent activity, by selecting, from among templates including at least one of a fraud risk evaluation template, a user alert template, a user procedure guidance template, and an emergency notification template, a template to be used, and embedding the character information and the analysis result into the selected template.

### Supplementary 3

The system according to supplementary 1,
wherein the processor is configured to
switch, in response to operation information from the user device, between normal call handling and automatic handling by the generative information processing model, and, when the automatic handling is selected, generate acoustic information on the basis of the response character string and cause the acoustic information to be transmitted, via a communication path, to a counterpart terminal.

What is claimed is:

1. A system comprising:
circuitry configured to:
acquire, via a communication interface coupled to a packet-switched network, voice data from a communication session, and convert the voice data into text data;
apply a determination model trained by a machine learning scheme to the text data to analyze expression patterns and calculate a possibility of fraudulent activity and a risk level;
generate a prompt sentence including conditions for response generation based on an analysis result from the determination model and the text data, dynamically adjusting a response policy and a response style in the prompt sentence according to the risk level;
input the prompt sentence to a generative neural network model to cause the generative neural network model to generate a response as text, and convert the generated text into voice data; and
transmit the voice data via the communication interface to a counterpart terminal to output the voice data as an automatic response during the communication session.

2. The system according to claim 1, wherein the circuitry is configured to convert the voice data into text data by applying an acoustic model and a language model to generate a text transcription, and storing the text transcription with timestamp metadata in a storage device.

3. The system according to claim 2, wherein the circuitry is configured to apply the determination model by computing feature representations of the text data using a trained encoder, applying a fraud classification head to produce fraud probability scores and a fraud risk level, and storing the fraud probability scores and the fraud risk level in the storage device.

4. The system according to claim 3, wherein the circuitry is configured to dynamically adjust the response policy in the prompt sentence by selecting a response strategy from a set of predefined strategies indexed by fraud risk level, and encoding the selected strategy as an instruction in the prompt sentence to the generative neural network model.

5. The system according to claim 1, wherein the circuitry is configured to, when the possibility of fraudulent activity exceeds a predetermined criterion, generate notification information including at least the risk level, a portion of the text data, and a summary of response content generated by the generative neural network model, and transmit the notification information to a user terminal via the communication interface.

6. The system according to claim 5, wherein the circuitry is configured to cause the user terminal to display the notification information and to provide operation information enabling a user to select continuation or termination of the communication session.

7. The system according to claim 1, wherein the circuitry is configured to receive, from a user terminal via the communication interface, a single operation instruction to switch a call response mode from a user response mode to the automatic response mode, and to activate the automatic response mode that uses the generative neural network model to handle subsequent voice exchanges in the communication session.

8. The system according to claim 7, wherein the circuitry is configured to deactivate the automatic response mode and restore the user response mode upon receiving a mode-termination instruction from the user terminal via the communication interface.

9. The system according to claim 1, wherein the circuitry is configured to continuously acquire voice data during an ongoing communication session, update the text data, the fraud analysis result, and the risk level in a time-series manner, and use the updated information as context for subsequent prompt sentences to monitor fraudulent activity over the entire duration of the communication session.

10. The system according to claim 9, wherein the circuitry is configured to detect a change in the risk level between successive time intervals, update the response policy in the prompt sentence accordingly, and re-invoke the generative neural network model with the updated prompt sentence.

11. The system according to claim 1, wherein the circuitry is configured to train the determination model using typical expression patterns of fraudulent activity and associated fraud risk indices, and to update the determination model by accumulating new text data and risk assessment labels from resolved communication sessions stored in a storage device.

12. The system according to claim 11, wherein the circuitry is configured to perform the model update by applying a supervised learning procedure to labeled communication session transcripts stored in the storage device, minimizing a loss function over fraud probability outputs, and updating model parameters using gradient-based optimization.

13. The system according to claim 1, wherein the circuitry is configured to generate evaluation information for detecting patterns indicating a possibility of fraudulent activity by computing n-gram frequency features and semantic embedding features from the text data, and combining the features in the determination model to produce a composite risk score.

14. The system according to claim 13, wherein the circuitry is configured to generate a response prompt sentence that instructs the generative neural network model to generate an autonomous response based on the risk information, and to transmit the generated response as voice data via the communication interface as part of a fully automated response flow.

15. The system according to claim 1, wherein the circuitry is configured to store prompt sentences, generated response texts, and associated risk levels as processing history in a storage device, and use accumulated processing history as additional context in subsequently generated prompt sentences to improve consistency of the automated response.

16. The system according to claim 1, wherein the circuitry is configured to transmit real-time monitoring data including the text data and the risk level to a supervisory terminal via the communication interface, enabling a human supervisor to monitor the automated response and intervene by transmitting an override instruction.

17. The system according to claim 16, wherein the circuitry is configured to receive an override instruction from the supervisory terminal via the communication interface and immediately deactivate the automatic response mode, routing the communication session back to a user response mode.

18. A system comprising:
circuitry configured to:
acquire, via a communication interface coupled to a packet-switched network, voice data from a communication session, convert the voice data into text data, and store the text data in a storage device;
apply a determination model trained by machine learning to the text data to compute fraud probability scores and a risk level based on expression patterns;
generate a prompt sentence with a response policy and response style determined by the risk level, and input the prompt sentence to a generative neural network model to generate a response as text;
convert the generated text into voice data and transmit the voice data via the communication interface to a counterpart terminal as an automatic response;
continuously update the text data, fraud analysis result, and risk level in a time-series manner during the ongoing communication session; and
generate notification information including the risk level and a summary of the response when the risk level exceeds a predetermined criterion, and transmit the notification information to a user terminal via the communication interface.

19. The system according to claim 18, wherein the circuitry is configured to receive a single operation instruction from the user terminal to switch between a user response mode and the automatic response mode.

20. A method comprising:
acquiring, via a communication interface coupled to a packet-switched network, voice data from a communication session, and converting the voice data into text data;
applying a determination model trained by a machine learning scheme to the text data to analyze expression patterns and calculate a possibility of fraudulent activity and a risk level;
generating a prompt sentence including conditions for response generation based on an analysis result from the determination model and the text data, dynamically adjusting a response policy and a response style in the prompt sentence according to the risk level;
inputting the prompt sentence to a generative neural network model to cause the generative neural network model to generate a response as text, and converting the generated text into voice data; and
transmitting the voice data via the communication interface to a counterpart terminal to output the voice data as an automatic response during the communication session.
